(19) United States
(12) Patent Application Publication
(10) Pub. No.: US 2012/0130848 A1
(43) Pub. Date: May 24, 2012

(54) Apparatus, Method, And Computer Program For Selecting Items

(75) Inventors: Ichiro Shishido, Zushi-shi (JP); Konosuke Matsushita, Kawasaki-shi (JP)

(73) Assignee: JVC KENWOOD Corporation, Kanagawa (JP)

(21) Appl. No.: 13/300,770

(22) Filed: Nov. 21, 2011

(30) Foreign Application Priority Data
Nov. 24, 2010 (JP) 2010-261813

(51) Int. Cl. G06Q 30/02

(52) U.S. Cl. 705/26.7

(57) ABSTRACT

A similar item set making section makes a similar item set corresponding to a target item. With respect to a first set of some or all of items in the similar item set, a first rate calculating section calculates a first rate. An item characteristic value calculating section calculates an item characteristic value by using the first rate. An item selecting section makes, from items in the similar item set, an associated item set corresponding to the target item. Recommended item conditions are for deciding whether or not an item should be recommended. The associated item set is designed so that when the item characteristic value satisfies prescribed item characteristic value conditions, the rate of the number of items satisfying recommended item conditions in the associated item set to the number of all items therein is greater than the first rate and smaller than 1.

### BACKGROUND OF THE INVENTION

1. Field of the Invention

This invention relates to an apparatus, a method, and a computer program for selecting an item or items associated with a certain or specified item.

2. Description of the Related Art

In recent years, as digital technologies and network technologies have progressed, there have been more cases where items such as digital contents and goods are distributed or sold by use of a network. Accordingly, there are increased needs for technologies of selecting an information piece or pieces about an item or items desired by a user from information pieces about many items, and providing the selected information piece or pieces to the user. A technology has been proposed which provides an information piece or pieces about an item or items accorded with user's taste and interest in response to information about the use of items by the user and information about the evaluation of the items by the user.

As disclosed in Japanese patent application publication numbers 2001-236405 and 2001-202571, a technology has been proposed which recommends items not only accorded with user's taste and interest but also a policy of a seller who sells the items.

Japanese patent application publication number 2002-304537 discloses that information about items associated with an item purchased by a user is provided to the user.

Japanese application 2001-236405 discloses that a seller prepares recommendation rules for goods recommendation, and a recommendation rule fitted to a user is selected therefrom on the basis of information about goods purchased by the user and web pages accessed by the user in the past before goods (items) are recommended according to the selected recommendation rule. Thereby, items accorded with not only user's taste but also a sales policy of the seller can be recommended to the user.

Japanese application 2001-202571 discloses that information pieces about goods purchased by a customer in the past are accumulated, and the accumulated information pieces are referred to and thereby campaign goods suited to the customer are selected from all campaign goods according to a goods strategy of a seller before the selected campaign goods are indicated. Thereby, campaign goods corresponding to user's purchase history can be recommended to a user.

However, in the methods disclosed by Japanese applications 2001-236405 and 2001-202571, all goods recommended to users are limited to items accorded with a sales policy of a seller. Thus, recommendation information given to a user tends to be toward particular goods and particular fields, and is not always attractive to the user who receives the recommendation information.

In addition, since all the recommended goods are accorded with the sales policy of the seller, the user sometimes senses a common factor among the recommended goods and feels a high-pressure selling or aggressive peddling attitude of the seller. Thus, there is a conceivable case where users do not obediently accept recommended goods and have a distrust of a seller so that providing recommendation information does not result in an increase in sales of goods.

Moreover, in the case where information about items associated with an item purchased by a user is provided to the user as disclosed by Japanese application 2002-304537, if the provided information is limited to that accorded with a sales policy of a seller, the provided information is not always attractive to the user. Thus, it is conceivable that the user does not obediently accept the provided information and has a distrust of the seller, and that providing the information about the associated items does not result in an increase in sales of items.

### SUMMARY OF THE INVENTION

Accordingly, it is an object of this invention to provide an apparatus, a method, and a computer program for providing associated item information which closely relates to a certain or specified item, which moderately reflects seller's sales policy, and which is easily acceptable by a user.

A first aspect of this invention provides an item selecting apparatus comprising a similar item set making section selecting a first prescribed number of items or less items in order of degree of similarity with a target item from the highest or items with degrees of similarity with the target item which are equal to or greater than a first prescribed value, and making the selected items into a similar item set corresponding to the target item; a first rate calculating section calculating, with respect to a first set of items being some or all of the items in the similar item set, calculating a first rate of the number of items satisfying recommended item conditions representing conditions for judging as items to be recommended to the number of all items; an item characteristic value calculating section calculating an item characteristic value representing the strength of a relation between the target item and the recommended item conditions by using the first rate; and an item selecting section selecting, from items in the similar item set, items including items satisfying the recommended item conditions to make an associated item set corresponding to the target item; wherein the item selecting section makes the associated item set so that when the item characteristic value satisfies prescribed item characteristic value conditions, the rate of the number of items in the associated item set which satisfy the recommended item conditions to the number of all items in the associated item set will be greater than the first rate and smaller than 1 except for a case where the first rate is 1.

A second aspect of this invention is based on the first aspect thereof, and provides an item selecting apparatus wherein when the item characteristic value does not satisfy the prescribed item characteristic value conditions, the item selecting section makes the associated item set so that the rate of the number of items in the associated item set which satisfy the recommended item conditions to the number of all items in the associated item set will be the first rate.

A third aspect of this invention is based on the first aspect thereof, and provides an item selecting apparatus further comprising a second rate calculating section making a second set being a set of items including items except the items in the first set, the second rate calculating section calculating, with respect to the second set, a second rate in number of items satisfying the recommended item conditions, wherein the item characteristic value calculating section calculates the item characteristic value for the target item by using the first rate and the second rate.

A fourth aspect of this invention is based on the third aspect thereof, and provides an item selecting apparatus wherein the second rate calculating section makes a comparison item set of one or more items except the target item, and calculates degrees of similarities between each item and other items in the comparison item set, and selects a second prescribed number of items or less items in order of calculated similarity degree from the highest or selects items corresponding to calculated similarity degrees equal to or greater than a second prescribed value to make the second set.

A fifth aspect of this invention is based on the third aspect thereof, and provides an item selecting apparatus wherein the second rate calculating section calculates degrees of similarities between the target item and items except the target item, and selects items in ranks later than that corresponding to the first prescribe number if the items are sorted in order of calculated similarity degree from the highest or selects items corresponding to calculated preference degrees less than the first prescribed value to make the second set.

A sixth aspect of this invention is based on the third aspect thereof, and provides an item selecting apparatus wherein the second rate calculating section calculates agreement degrees representing degrees to which the items in the second set satisfy the recommended item conditions respectively, and calculates a representative value of the calculated agreement degrees and labels the calculated representative value as the second rate.

A seventh aspect of this invention is based on the third aspect thereof, and provides an item selecting apparatus wherein the item characteristic value calculating section calculates the item characteristic value by using a value resulting from subtracting the second rate from the first rate or a value resulting from dividing the first rate by the second rate.

An eighth aspect of this invention is based on the first aspect thereof, and provides an item selecting apparatus wherein the first rate calculating section calculates agreement degrees representing degrees to which the items in the first set satisfy the recommended item conditions respectively, and calculates a representative value of the calculated agreement degrees and labels the calculated representative value as the first rate.

A ninth aspect of this invention is based on the first aspect thereof, and provides an item selecting apparatus wherein the item selecting section makes the associated item set by using both items satisfying the recommended item conditions in the similar item set, and items not satisfying the recommended item conditions in the similar item set.

A tenth aspect of this invention is based on the first aspect thereof, and provides an item selecting apparatus wherein in cases where the item characteristic value satisfies the prescribed item characteristic value conditions, the item selecting section makes the associated item set so that the rate of the number of items in the associated item set which satisfy the recommended item conditions to the number of all items in the associated item set will be greater than the first rate and smaller than 1 except a case where the first rate is 1, and will increase as the first rate increases.

An eleventh aspect of this invention is based on the first aspect thereof, and provides an item selecting apparatus wherein the prescribed item characteristic value conditions are conditions that the item characteristic value is between a third prescribed value and a fourth prescribed value greater than the third prescribed value, and wherein when the item characteristic value conditions are satisfied, the item selecting section makes the associated item set so that the rate of the number of items in the associated item set which satisfy the recommended item conditions to the number of all items in the associated item set will be greater than the first rate and smaller than 1 except a case where the first rate is 1, and wherein when the item characteristic value is greater than the fourth prescribed value, the item selecting section makes the associated item set so that the rate of the number of items in the associated item set which satisfy the recommended item conditions to the number of all items in the associated item set will be smaller than the first rate.

A twelfth aspect of this invention is based on the first aspect thereof, and provides an item selecting apparatus wherein use histories represent correspondences between users and items used by the users, and a range in ranks of the items in the use histories about number of times of item use or a range in ranks of the items in the use histories about number of users who have used an item is set in the recommended item conditions.

A thirteenth aspect of this invention is based on the first aspect thereof, and provides an item selecting apparatus wherein use histories represent correspondences between users and items used by the users, and a range in numbers of times of use of the items in the use histories or a range in per-item numbers of users who have used the items in the use histories is set in the recommended item conditions.

A fourteenth aspect of this invention is based on the first aspect thereof, and provides an item selecting apparatus further comprising an output section outputting the associated item set via a network.

A fifteenth aspect of this invention provides a method of selecting items in an information processing apparatus. The method comprises a similar item set making step of selecting a first prescribed number of items or less items in order of degree of similarity with a target item from the highest or items with degrees of similarity with the target item which are equal to or greater than a first prescribed value, and making the selected items into a similar item set corresponding to the target item; a first rate calculating step of calculating, with respect to a first set of items being some or all of the items in the similar item set, calculating a first rate of the number of items satisfying recommended item conditions representing conditions for judging as items to be recommended to the number of all items; an item characteristic value calculating step of calculating an item characteristic value representing the strength of a relation between the target item and the recommended item conditions by using the first rate; and an item selecting step of selecting, from items in the similar item set, items including items satisfying the recommended item conditions to make an associated item set corresponding to the target item; wherein the item selecting step makes the associated item set so that when the item characteristic value satisfies prescribed item characteristic value conditions, the rate of the number of items in the associated item set which satisfy the recommended item conditions to the number of all items in the associated item set will be greater than the first rate and smaller than 1 except for a case where the first rate is 1.

A sixteenth aspect of this invention is based on the fifteenth aspect thereof, and provides a method wherein when the item characteristic value does not satisfy the prescribed item characteristic value conditions, the item selecting step makes the associated item set so that the rate of the number of items in the associated item set which satisfy the recommended item conditions to the number of all items in the associated item set will be the first rate.

A seventeenth aspect of this invention is based on the fifteenth aspect thereof, and provides a method further comprising a second rate calculating step of making a second set of items including items except the items in the first set, the second rate calculating step calculating, with respect to the second set, a second rate of the number of items satisfying the recommended item conditions to the number of all items, wherein the item characteristic value calculating step calculates the item characteristic value for the target item by using the first rate and the second rate.

An eighteenth aspect of this invention provides a computer program enabling an information processing apparatus to function as a similar item set making section selecting a first prescribed number of items or less items in order of degree of similarity with a target item from the highest or items with degrees of similarity with the target item which are equal to or greater than a first prescribed value, and making the selected items into a similar item set corresponding to the target item; a first rate calculating section calculating, with respect to a first set of items being some or all of the items in the similar item set, calculating a first rate of the number of items satisfying recommended item conditions representing conditions for judging as items to be recommended to the number of all items; an item characteristic value calculating section calculating an item characteristic value representing the strength of a relation between the target item and the recommended item conditions by using the first rate; and an item selecting section selecting, from items in the similar item set, items including items satisfying the recommended item conditions to make an associated item set corresponding to the target item; wherein the item selecting section makes the associated item set so that when the item characteristic value satisfies prescribed item characteristic value conditions, the rate of the number of items in the associated item set which satisfy the recommended item conditions to the number of all items in the associated item set will be greater than the first rate and smaller than 1 except for a case where the first rate is 1.

A nineteenth aspect of this invention is based on the eighteenth aspect thereof, and provides a computer program wherein when the item characteristic value does not satisfy the prescribed item characteristic value conditions, the item selecting section makes the associated item set so that the rate of the number of items in the associated item set which satisfy the recommended item conditions to the number of all items in the associated item set will be the first rate.

A twentieth aspect of this invention is based on the eighteenth aspect thereof, and provides a computer program enabling the information processing apparatus to further function as a second rate calculating section making a second set of items including items except the items in the first set, the second rate calculating section calculating, with respect to the second set, a second rate of the number of items satisfying the recommended item conditions to the number of all items, wherein the item characteristic value calculating section calculates the item characteristic value for the target item by using the first rate and the second rate.

This invention has the following advantage. It is possible to provide associated item information which closely relates to a certain or specified item, which moderately reflects seller's sales policy, and which is easily acceptable by a user.

### BRIEF DESCRIPTION OF THE DRAWINGS

FIG. 1 is a block diagram showing the structure of the whole of a system (network system) according to a first embodiment of this invention.

FIG. 2 is a block diagram showing another structure of the system in the first embodiment of this invention.

FIG. 3 is a block diagram showing the structure of an item providing server in the system of FIG. 1 or FIG. 2.

FIG. 4 is a diagram showing an example of the store format for an item store section in FIG. 3.

FIG. 5 is a diagram showing an example of the store format for a recommendation information store section in FIG. 3.

FIG. 6 is a block diagram showing the structure of an information selecting device in the system of FIG. 1 or FIG. 2.

FIG. 7 is a diagram showing an example of the store format for an item attribute store section in FIG. 6.

FIGS. 8(a)-8(c) are diagrams showing examples of the store format for a use history store section in FIG. 6.

FIGS. 9(a)-9(d) are diagrams showing examples of the store format for a recommended item condition store section in FIG. 6.

FIG. 10 is a diagram showing a table in which the IDs of base items, the IDs of similar items, and the degrees of similarity therebetween are related with each other in the first embodiment of this invention.

FIG. 11 is a flowchart of operation of the whole of the system in FIG. 1 or FIG. 2.

FIG. 12 is a diagram showing an example of indication of item list information in the first embodiment of this invention.

FIG. 13 is a diagram showing an example of indication of recommendation information in the first embodiment of this invention.

FIG. 14 is a flowchart of operation in which the information selecting device makes the recommendation information and sends it, and the item providing server receives it in the system of FIG. 1 or FIG. 2.

FIG. 15 is a flowchart of a similar item set making process in the first embodiment of this invention.

FIG. 16 is a flowchart of a first method of making the recommendation information in the first embodiment of this invention.

FIGS. 17(a) and 17(b) are diagrams each showing a relation between a first rate R1 and a third rate R3 in the first embodiment of this invention.

FIG. 18 is a flowchart of a second method of making the recommendation information in the first embodiment of this invention.

FIGS. 19(a) and 19(b) are diagrams each showing another relation between the first rate R1 and the third rate R3 in the first embodiment of this invention.

FIG. 20 is a block diagram showing the structure of an information selecting device in a system (network system) according to a second embodiment of this invention.

FIG. 21 is a flowchart of a similar item set making process in the second embodiment of this invention.

### DETAILED DESCRIPTION OF THE INVENTION

### First Embodiment

Structure and operation of a network system in a first embodiment of this invention will be sequentially described with reference to drawings.

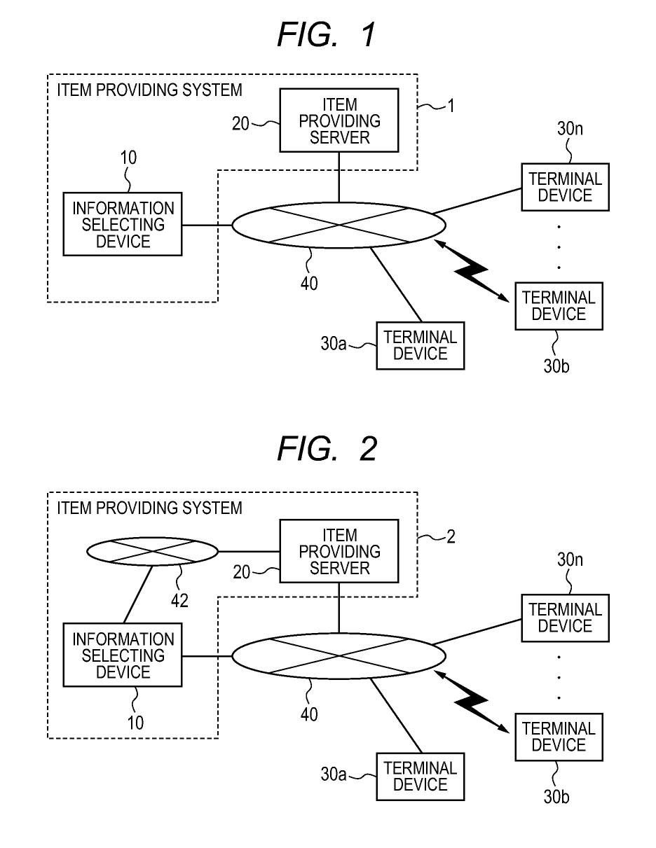

FIG. 1 is a block diagram of the whole of the network system in the first embodiment of this invention. As shown in FIG. 1, the network system is designed so that an information selecting device 10, an item providing server 20, and one or more terminal devices 30 (30a, 30b, . . . 30n in the drawing) are connected by a network 40. The information selecting device 10 operates to select an information piece or pieces about, for example, an item or items. The information selecting device 10 and the item providing server 20 form an item providing system 1 doing service such as item providing service for a user using a terminal device 30. The network 40 may be a wide area network such as the Internet. The connection between the terminal devices 30 and the network 40 is on a wired basis or a wireless basis.

FIG. 2 shows a network system which may replace that in FIG. 1. In the network system of FIG. 2, an item providing server 20 and one or more terminal devices 30 (30a, 30b, . . . 30n) are connected to a network 40, and an information selecting device 10 is connected to the item providing server 20 via a network 42 separate from the network 40. In this case, the information selecting device 10 and the item providing server 20 that are connected by the network 42 form an item providing system 2. The network 42 may be, for example, LAN (local area network). In view of maintaining security, it is preferable to limit a direct access to the information selecting device 10 from each of the terminal devices 30.

The network system may have one of various structures not limited to those in FIGS. 1 and 2. For example, the information selecting device 10 and the item providing server 20 may be formed by a common device. Each of the information selecting device 10 and the item providing server 20 may be formed by a plurality of devices.

A description will be made below as to an exemplary case where the network system has the structure in FIG. 1.

The item providing server 20 is a device which provides items and information pieces about the items in response to a request from each of the terminal devices 30. The items are various goods, services, or digital contents of, for example, text, audio, music, or video. The items may be information pieces about persons, real estates, or financial goods or commodities. The items may be material or immaterial. The items may be toll ones or toll-free ones.

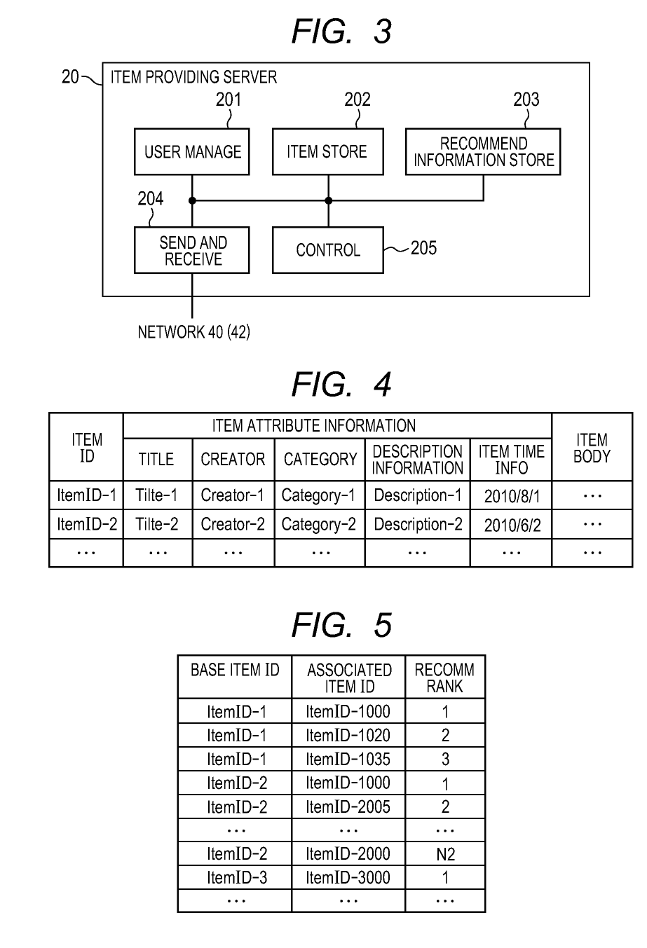

FIG. 3 is a block diagram showing the structure of the item providing server 20. As shown in FIG. 3, the item providing server 20 includes a user managing section 201, an item store section 202, a recommendation information store section 203, a sending and receiving section 204, and a control section 205. The item providing server 20 may be formed by a general computer including a CPU, a RAM, a ROM, an HDD (hard disk drive), a network interface, and others. The general computer executes a program for performing below-mentioned processes, and thereby serves as the item providing server 20. The program is stored in, for example, the ROM or the HDD.

The user managing section 201 stores user IDs for identifying users who use the terminal devices 30 or terminal device IDs for identifying the terminal devices 30. In the present embodiment of this invention, users are identified through the use of user IDs. In the case where cellular phones are used as the terminal devices 30, the terminal device IDs which can be obtained at the time of connection with the terminal devices 30 may be used instead of the user IDs. The user IDs and the terminal device IDs are called use subject IDs. An entrance process needs to be performed before a new user starts using an item. The item providing server 20 stores, in the user managing section 201, a user subject ID related to an entrance process that has just been completed. If necessary, user attribute information pieces representing, for example, passwords, names, birthdays, and contact addresses may be stored in the user managing section 201 in such a manner as to be in correspondence with user subject IDs.

The item store section 202 stores information pieces about items provided by the item providing server 20. The item store section 202 stores the information pieces about the items in a table format such as shown in FIG. 4.

As shown in FIG. 4, the item store section 202 stores item IDs, item attribute information pieces, and item bodies in a manner such as to relate them with each other. The item IDs are for identifying items respectively. The item attribute information pieces represent the “titles”, “creators”, and “categories” of the items, and include “description information” pieces and “item time information” pieces about the items.

The “creators” have meanings in a wide range depending on item types. The creators are, for example, performers, players, lyric writers, composers, writers, producers, directors, or manufactures of the items.

The “categories” are those used in classifying the items according to prescribed references. For example, in the case where the items are music pieces, the “categories” are genres such as “rock”, “jazz”, “classic”, and “folk”. In the case where the items are movies, the “categories” are genres such as “SF”, “action”, “comedy”, and “animation”. The “categories” may be countries or areas of creators such as “Japan”, “USA”, “UK”, and others. The “categories” may relate to atmospheres and moods of the items, and may be “healing”, “exciting”, “dramatic”, and others. The “description information” pieces represent the outlines or summaries of the items or the descriptions of the background of making the items.

The “item time information” pieces represent the times (moments) at which the items were made. The “item time information” pieces may represent the times at which the items were registered in the item providing server 20 or the times at which providing the items were started. In the present embodiment of this invention, the dates such as “Jan. 1, 2010” are used as the unit for the times. Another unit may be used. For example, the dates and times such as those up to second unit such as “Jan. 1, 2010, 10-hour 15-minute 20-second” may be used. The dates and times such as those up to millisecond unit may be used. The dates up to month unit such as “January in 2010” may be used. The dates up to quarter unit such as “2010, 1Q” may be used. The dates in year unit such as “2010” may be used. The dates in unit greater than year unit such as “during 10 years from 2000” may be used.

Regarding the item attribute information pieces in the item store section 202, a plurality of attribute heads (headlines) of the same type may be assigned to one item. For example, one item may be assigned three different categories. The item attribute information pieces mentioned here are mere examples, and should not be limited to the above-mentioned ones. Attribute heads such as “price” and “size” may be used.

Each of the item bodies can be text data or binary data forming the related item itself or an information piece representing the position where the related item exists (for example, URL: Uniform Resource Locator). The item bodies are stored regarding items that are, for example, digital contents which can be distributed to the terminal devices 30 via the network 40. Storing the item bodies may be omitted in the case where the related items are, for example, goods or services.

The recommendation information store section 203 stores recommendation information pieces received from the information selecting device 10. Each recommendation information piece represents an item or items associated with an item designated by a terminal device 30. Such a designated item is called a base item, a certain item, or a specified item.

The recommendation information store section 203 can store recommendation information pieces in a format such as shown in FIG. 5. With reference to FIG. 5, the recommendation information store section 203 stores base item IDs, associated item IDs, and recommendation ranks in a manner such as to relate them with each other. The base item IDs are IDs of base items each being a trigger for outputting the recommendation information. The associated item IDs are IDs of items associated with the base items. An item or items associated with a base item are called an associated item or items. In the recommendation information store section 203, one base item ID is assigned one or more associated item IDs.

The recommendation ranks are order numbers about recommending associated items for each base item ID. As the recommendation rank is smaller in numeral, the related associated item is presented to a user with higher priority. Recommendation degrees may be stored in place of the recommendation ranks. As the recommendation degree is greater, the related associated item is presented to a user with higher priority. Storing the recommendation ranks may be omitted. In this case, the recommendation information pieces in the recommendation information store section 203 are handled with the same recommendation rank.

The sending and receiving section 204 performs a process of sending and receiving data to and from the information selecting section 10 and the terminal devices 30 via the network 40 (further via the network 42 in the case of the structure in FIG. 2). The control section 205 performs the control of the whole of the item providing server 20.

Each of the terminal devices 30 can be used by a user, and may be formed by a general computer including a CPU, a RAM, a ROM, an HDD (hard disk drive), a network interface, and others. A program for obtaining item information pieces from the item providing server 20 is installed in each of the terminal devices 30. A representative example of this program is a web browser. Each of the terminal devices 30 may be formed by a portable terminal device or a cellular phone having, for example, a browser function.

In the case where a computer is used as each of the terminal devices 30, an indication device such as a display and an input device (not shown) for receiving operation commands from a user are connected thereto. Examples of the input device are a remote control device, a track ball, a mouse, and a keyboard. In the case where a cellular phone is used as each of the terminal devices 30, an indication device and an input device are contained therein. For convenience, a description will be made below as to cases where an indication device and an input device are connected to each of the terminal devices 30.

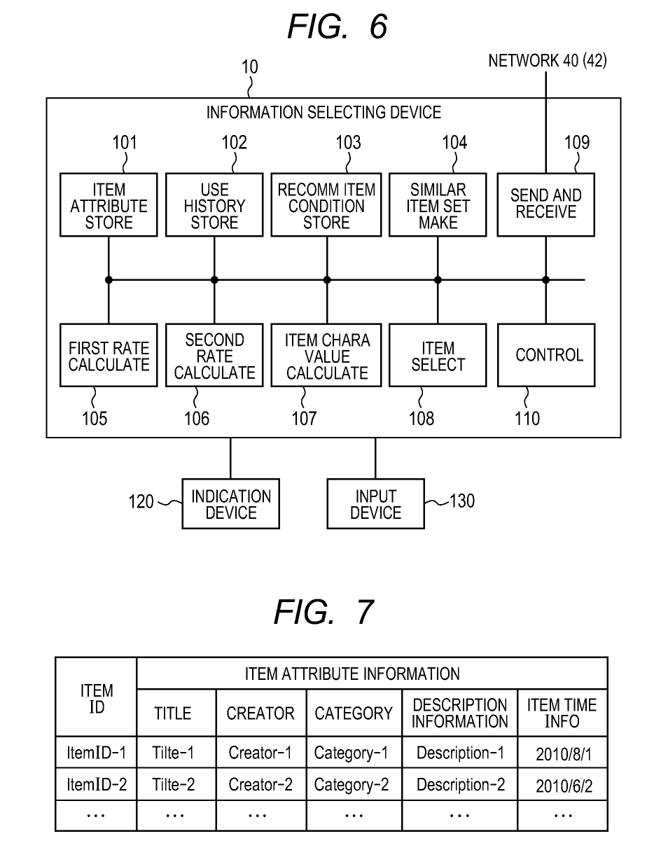

FIG. 6 is a block diagram showing the structure of the information selecting device 10 which serves as an item selecting device. The information selecting device 10 serves to select an associated item or items for each base item. As shown in FIG. 6, the information selecting device 10 includes an item attribute store section 101, a use history store section 102, a recommended item condition store section 103, a similar item set making section 104, a first rate calculating section 105, a second rate calculating section 106, an item characteristic value calculating section 107, an item selecting section 108, a sending and receiving section 109, and a control section 110. An indication device 120 and an input device 130 are connected to the information selecting device 10. The indication device 120 serves to indicate necessary information to a manager about the information selecting device 10. The input device 130 is, for example, a keyboard or a mouse operated by the manager.

The information selecting device 10 may be formed by a general computer including a CPU, a RAM, a ROM, an HDD (hard disk drive), a network interface, and others. The general computer executes a program of implementing processes as mentioned later, and thereby functions as the information selecting device 10.

The information selecting device 10 may be formed by a plurality of computers. For example, to disperse load, computers are assigned to one processing block of the information selecting device 10 and thereby dispersedly processing is implemented. According to another example, one processing block of the information selecting device 10 is implemented by one computer while another processing block thereof is implemented by another computer, so that dispersedly processing can be carried out.

The item attribute store section 101 uses a data store format shown in FIG. 7. With reference to FIG. 7, the item attribute store section 101 stores item IDs and item attribute information pieces in a manner such as to relate them with each other. The item IDs and the item attribute information pieces are similar to those in the item store section 202 of the item providing server 20 which are shown in FIG. 4. The item attribute store section 101 differs from the item store section 202 in that item bodies are absent. Although the information selecting device 10 does not need item bodies, data in the item store section 202 may be used as it is before being stored. Alternatively, the item attribute store section 101 may be omitted by designing the information selecting device 10 to be capable of directly referring to data in the item store section 202.

As previously mentioned, the item attribute information pieces represent the “titles”, “creators”, and “categories” of the items, and include “description information” pieces and “item time information” pieces about the items. As will be mentioned later, in the case where the recommended item condition store section 103 stores only recommended item conditions having no relation with the item attribute information pieces, the item attribute store section 101 may be omitted.

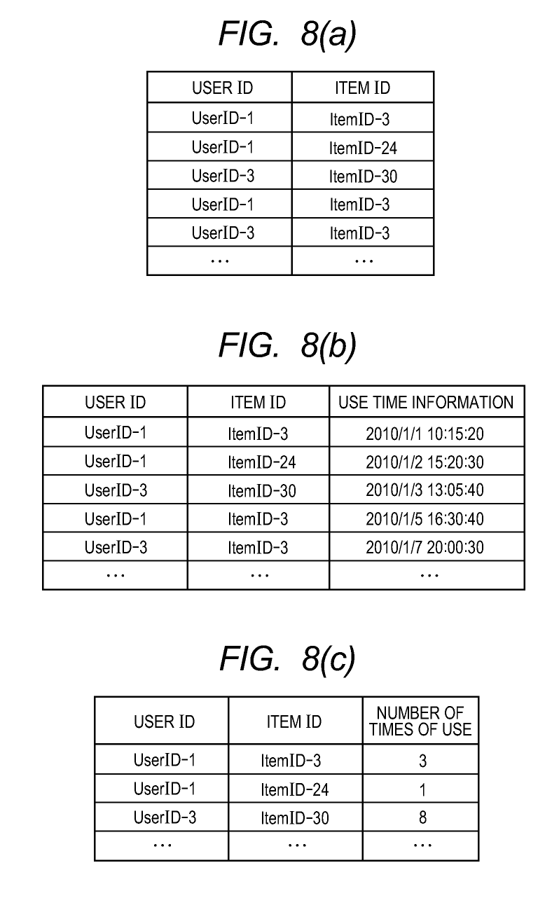

The control section 110 performs various processes for controlling the whole of the information selecting device 10. For example, the control section 110 stores use histories in the use history store section 102. The use histories in the use history store section 102 are of a table format such as shown in FIG. 8(a), 8(b), or 8(c). The use histories indicate correspondences between the item IDs of items designated by users and the user IDs contained in below-mentioned use request messages sent from the item providing server 20.

The use history store section 102 uses, for example, one of various store forms shown in FIGS. 8(a), 8(b), and 8(c). FIG. 8(a) shows a store form designed so that user IDs and item IDs are stored while being related with each other. One use request message corresponds to one row in the table of FIG. 8(a). With reference to FIG. 8(a), both the first row and the fourth row in the table indicate a combination of “UserID-1” and “ItemID-3”. As understood from this fact, table row data is added and stored for each use request message even in the case where a same combination of a user ID and an item ID recurs. Thus, the number of times of use of each item identified by an item ID, and the number of users who have used each item, that is, the number of user IDs related to each item can be easily counted by another processing section. In the case where one use request message contains a plurality of item IDs, different table rows are assigned to these item IDs respectively and they are stored.

FIG. 8(b) shows a store form designed so that user IDs, item IDs, and use time information pieces are stored while being related with each other. Similar to the form of FIG. 8(a), one use request message corresponds to one row in the table of FIG. 8(b). In the case where a use request message contains a use time information piece, the use time information piece is extracted therefrom before being stored. In the case where a use request message does not contain a use time information piece, the time of the reception of the use request message by the information selecting device 10 is detected by using a clock in the control section 110 and the detected time is stored as a use time information piece.

The format of the use time information pieces uses day and time units up to second unit such as “Jan. 1, 2010, 10-hour 15-minute 20-second”. The dates and times such as those up to millisecond unit may be used. The dates such as those up to day unit may be used. The dates up to month unit may be used. The dates in year unit may be used. Other day and time formats may be used. The value of evaluation of an item by a user (the numerical value indicative of the degree at which the user likes or dislikes the item: for example, like=3, neither like nor dislike=2, dislike=1) may be contained in a use request message, and the user ID, the item ID, the use time information piece, and the evaluation value may be stored in the use history store section 102 while being related with each other.

The use history store section 102 may use a store format designed so that as shown in FIG. 8(c), use time information pieces are omitted and user IDs, item IDs, and the numbers of times of use are related with each other. In the case where the similar item set making section 104 does not utilize use time information pieces as mentioned later, the storing is implemented with the format of FIG. 8(c) and thereby the necessary memory capacity can be reduced. In the case where a use request message contains the value of evaluation of an item by a user, a user ID, an item ID, the number of times of use, and the evaluation value may be stored in the use history store section 102 while being related with each other.

The recommended item condition store section 103 is a memory area for storing recommended item condition data representing conditions of items (recommended item conditions) which an item seller desires to recommend to users. Among items selected by another processing block, an item or items which satisfy conditions registered as recommended item conditions are decided to be an item or items accorded with the recommended item conditions.

The seller can freely set the recommended item conditions depending on item stock conditions, a stocking price, a sales policy, and others. A manager of the item providing server 20 entrusts a manager of the information selecting device 10 with the inputting of the recommended item condition data. Alternatively, the manager of the item providing server 20 may register the recommended item condition data in the item providing server 20 before sending the registered data to the information selecting device 10.

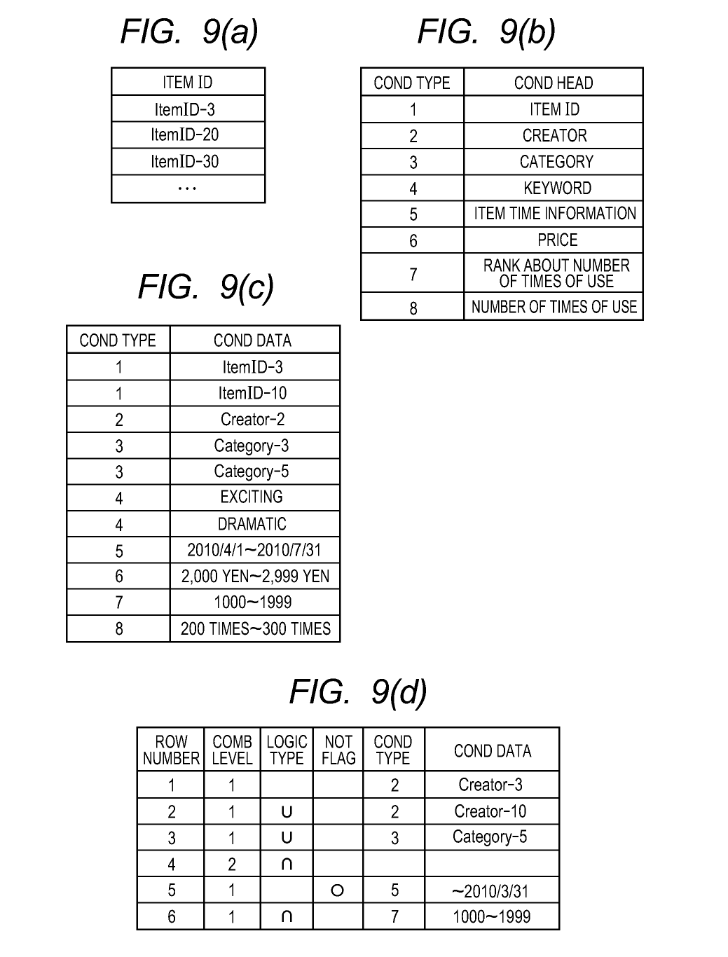

The recommended item condition store section 103 can store the recommended item condition data in the form of a table such as shown in FIG. 9(a). The table of FIG. 9(a) corresponds to the simplest store format, and the item IDs of items designated by the manager of the information selecting device 10 are stored through the use of the input device 130.

The recommended item condition store section 103 may store the recommended item condition data in the form of a table such as shown in FIG. 9(c) by using rules such as shown in FIG. 9(b) for making condition types and condition heads correspond to each other.

As shown in FIG. 9(b), the condition type “1” indicates that the condition data is an item ID. The condition type “2” indicates that the condition data is a “creator”. In this case, the name of the creator or the creator ID is registered in the condition data. The condition type “3” indicates that the condition data is a “category”. In this case, the category name or the category ID is registered in the condition data. The condition type “4” indicates that the condition data is a “keyword”. In this case, when the keyword is contained in the contents of attribute heads such as a “title”, a “creator”, a “category”, and a “description information” piece in item attribute, it is decided that there is an accordance with the recommended item conditions. The condition type “5” indicates that the condition data is an “item time information” piece. As in the example of FIG. 9(c), the range defined by two “item time information” pieces may be stored. Alternatively, a single “item time information” piece may be stored. The condition type “6” indicates that the condition data is a “price”. As in the example of FIG. 9(c), the range between “prices” may be stored. Alternatively, a single “price” may be stored.

The condition type “7” represents a rank or a rank range regarding the number of times of use of a related item. The example of FIG. 9(c) shows that an item having a rank in the range between a rank of 1000 and a rank of 1999 measured from the greatest number of times of use is a target (an object). In this case, when 3000 different items are contained in the use histories in the use history store section 102, items medium in popularity are designated. In the case where data of the condition type “7” is stored in the recommended item condition store section 103, the control section 110 reads out use histories from the use history store section 102, and counts the number of times of use for each of item IDs contained in the read-out use histories. Then, the control section 110 sorts the counted numbers in order from the greatest before storing an item ID or IDs corresponding to a designated rank or a designated rank range in a memory area in the recommended item condition store section 103. In this process, the number of times of use may be counted for only each of use histories satisfying prescribed conditions, for example, conditions where use time information pieces are in a prescribed range. For each of the items, the number of users (the number of user IDs) who made use may be counted instead of the number of times of use. In this case, the items are ranked in order from the greatest number of users who made use, and a rank or a rank range is used as the recommended item condition data.

The condition type “8” represents the number of times of use of a related item. The example of FIG. 9(c) shows that an item corresponding to the number of times of use in the range between 200 and 300 is a target (an object). The control section 110 reads out use histories from the use history store section 102, and counts the number of times of use for each of item IDs contained in the read-out use histories before storing an item ID or IDs corresponding to a designated number or numbers of times in a memory area in the recommended item condition store section 103. Similar to the case of the condition type “7”, the number of users (the number of user IDs) who made use may be used instead of the number of times of use. In this case, with respect to the use histories in the use history store section 102, the number of users (the number of user IDs) who made use is counted for each item, and the counted number of users or a counted user number range is used as the recommended item condition data.

In the case where the condition types “2” to “6” are used, the item attribute store section 101 is necessary. In the case where the condition types “1”, “7”, and “8” are used, the item attribute store section 101 can be omitted.

By using the format of FIG. 9(c), various recommended item condition data pieces can be freely registered and stored. In the case where a plurality of rows (a plurality of rules) are registered in a table, it is good that an item corresponding to one or more rows is decided to be accorded with the recommended item conditions. This case corresponds to the fact that rows are combined by logical disjunction (OR) and the process is done. Rows of the same condition type may be combined by logical disjunction (OR) and rows of different condition types may be combined by logical product (AND), and the process may be done.

For example, taking out the first to third rows from the table of FIG. 9(c) results in the conditions (“ItemID-3”∪“ItemID-10”)∩“Creator-2” where “∩” denotes logical product (AND) and “∪” denotes logical disjunction (OR).

By using the store format of FIG. 9(c), it is possible to set various recommended item conditions with a high degree of freedom and follow a complicated sales policy of a seller.

A store format such as shown in FIG. 9(d) may be used. In this case, the control section 10 interprets a table as follows and gets final recommended item condition data. Condition types and condition data are the same in meaning as those in FIG. 9(c).

In order of combination level from the smallest, rows of the same combination level are combined. At that time, the table is divided into sections (blocks) each having rows with the same combination level and serial row numbers, and the blocks are sequentially processed in order of row number from the smallest.

In the example of FIG. 9(d), since rows with the combination level “1” are rows having row numbers “1” to “3” and row numbers “5” to “6” and a row with a row number “4” between them has a different combination level, division into two blocks is done. Specifically, division into a block “1” with row numbers “1” to “3” and a block “2” with row numbers “5” to “6” is done, and processing is made as to the block “1” with smaller row numbers first. The logical type in the row numbers “2” and “3” is logical disjunction “∪” and the three rows in the block “1” are combined by logical disjunction, and thereby there is obtained a condition equation as (“creator: Creator-3” or “creator: Creator-10” or “category: Category-5”).

In connection with combining the two rows in the block “2”, since a negative flag (not flag) is set in the row number “5” (“◯” in FIG. 9(d)), the row number “5” is interpreted as a negative form. An expression “˜2010/3/31” indicates that an item time information piece is on or before Mar. 31, 2010. Since the not flag is set “◯”, it is interpreted as a meaning that the item time information piece is after (later than) Mar. 31, 2010. Since the logic type in the row number “6” is logical product “∩”, the block “2” corresponds to a condition equation as (“an item time information piece is after Mar. 31, 2010” and “a rank about the number of times of use is between 1000 and 1999”).

Next, blocks are combined by using a logic type corresponding to a combination level greater in value by 1 than the combination level used in making the blocks. In the example of FIG. 9(d), the block “1” and the block “2” are combined by using logical product “∩” that is the logical type in the row number “4” having a combination level of “2”. Then, there is made a condition equation as ((“creator: Creator-3” or “creator: Creator-10” or “category: Category-5”) and (“an item time information piece is after Mar. 31, 2010” and “a rank about the number of times of use is between 1000 and 1999”)). An item or items which satisfy this condition equation are decided to be an item or items satisfying the recommended item conditions. By using the store format of FIG. 9(d), it is possible to set more various recommended item conditions with a higher degree of freedom.

In this way, by using a store format such as shown in FIG. 9(c) or FIG. 9(d), recommended item conditions can be flexibly set so that the number of items accorded with a sales policy can be prevented from being excessively small or large.

With respect to a base item being an object to be processed, the first rate calculating section 105 makes a first set being a set of items having high degrees of similarity with the base item. For the first set, the first rate calculating section 105 calculates a first rate equal to the ratio of the number of items accorded with the recommended item conditions to the number of all the items, and stores the calculated first rate in a memory area therein. Detailed steps of the processing by the first rate calculating section 105 will be described later.

With respect to a base item being an object to be processed, the second rate calculating section 106 makes a second set being a set of items except those in the first set. For the second set, the second rate calculating section 106 calculates a second rate equal to the ratio of the number of items accorded with the recommended item conditions to the number of all the items, and stores the calculated second rate in a memory area therein. The second set of items is a set of items having not so high degrees of similarity with the base item as compared with those in the first set. Detailed steps of the processing by the second rate calculating section 106 will be described later.

Each of the first rate calculating section 105 and the second rate calculating section 106 may not make a two-value decision as to whether or not a certain item is accorded with the recommended item conditions. In this case, for example, each of the first rate calculating section 105 and the second rate calculating section 106 finely calculates the degree of the match between an item and the recommended item conditions on a multiple-value basis or a continuous-quantity basis by using the number of rows in the table which are accorded with the recommended item conditions.

In the example of FIG. 9(c), when a certain item “A” has three item attribute information pieces “Category-3”, “Category-5”, and “exciting”, the match degree can be set to “3”. When another item “B” has two item attribute information pieces “Category-5” and “dramatic”, the match degree can be set to “2”. Both the two items “A” and “B” satisfy the recommended item conditions while the item “A” is higher in match degree. A normalized match degree may be calculated through the use of a value resulting from dividing an accorded condition number by the total number of the recommended item conditions (the number of rows in the table for storing the recommended item conditions) or a value resulting from dividing the accorded condition number by the maximum number of conditions with which a plurality of items are accorded.

With respect to a base item being an object to be processed, the item characteristic value calculating section 107 calculates an item characteristic value representing the strength of the relation between the base item and the recommended item conditions. The item characteristic value calculating section 107 stores the base item ID and the calculated item characteristic value in a memory area therein while making them in correspondence with each other. Detailed steps of the processing by the item characteristic value calculating section 107 will be described later.

The item selecting section 108 selects an associated item or items, which are suited to a base item being an object to be processed, by using the item characteristic value and the similar item set, and generates recommendation information from the selected associated item or items. Detailed steps of the processing by the item selecting section 108 will be described later.

The sending and receiving section 109 implements processes of sending and receiving data to and from the item providing server 20 via the network 40 or the network 42.

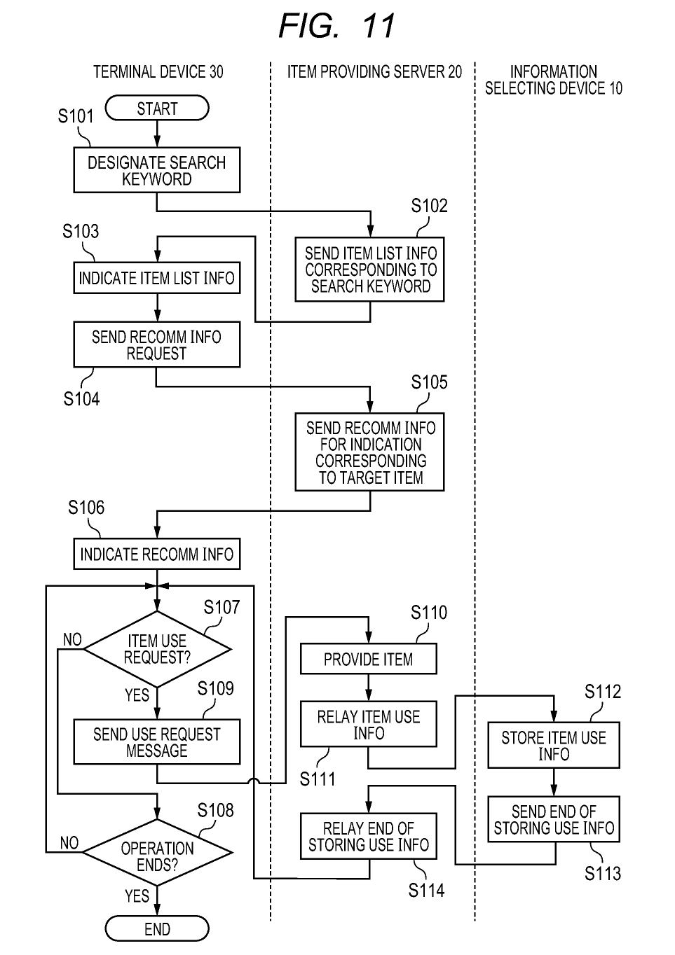

Operation of the whole of the system will be explained with reference to a flowchart in FIG. 11. First, in a step S101 of FIG. 11, a terminal device 30 sends a message of requesting item search to the system providing server 20 when receiving a designated search keyword from a user via the input device. This message contains the search keyword. The message may contain information for designating item category and use time in addition to the search keyword. By making the search keyword null (blank), the message may be designed to request information about all items that is possessed by the system providing server 20.

In a step S102, the item providing server 20 receives the item search message via the sending and receiving section 204, and makes information about a list of items corresponding to the designated search keyword while referring to the item store section 202. The item providing server 20 sends the item list information to the terminal device 30. This process by the item providing server 20 includes, for example, a step of extracting items having item attribute information pieces each containing the designated search keyword, and a step of combining the item attribute information pieces of the extracted items into the item list information.

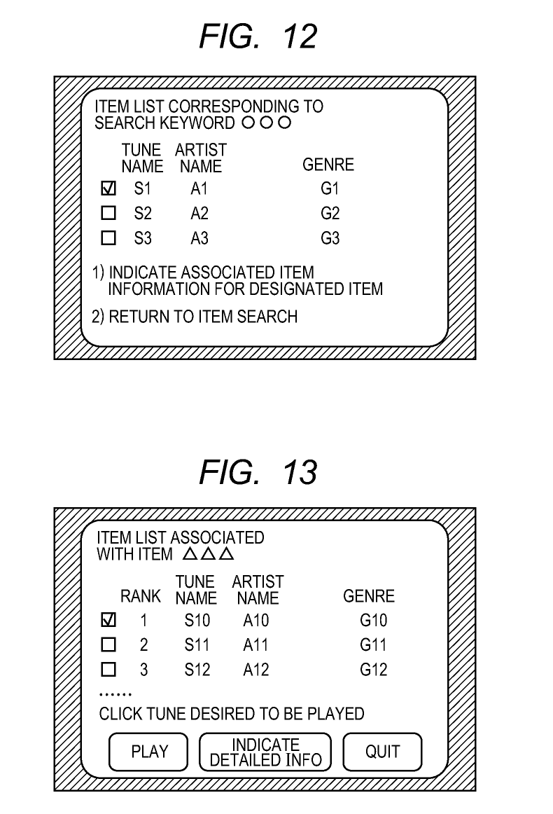

In a step S103, the terminal device 30 receives the item list information from the item providing server 20, and controls the indication device to indicate the item list information in a format such as shown in FIG. 12. According to the example in FIG. 12, items are music contents, and there are indicated tune names, artist names, and genres. Furthermore, a menu for indicating items associated with a designated item is indicated on a lower portion of the picture in FIG. 12.

For example, when desiring the indication of items associated with the tune name “S1”, the user puts a mark in a check box on a side of the tune name “S1” and then selects a menu number “1” by clicking. Thus, the user designates one among items having item attribute information pieces indicated by the indication device. The designated item is called the target item, and the ID of the designated item is called the target item ID. Item IDs are contained in the item list information although they are not indicated by the indication device, and the terminal device 30 manages the correspondence between the item IDs and the information pieces indicated by the indication device.

In a nest step S104, the terminal device 30 sends a message of requesting recommendation information to the item providing server 20. Specifically, the terminal device 30 adds, to the recommendation information request message, the ID of the target item designated by the step S103 for the indication of associated items before sending the resultant recommendation information request message to the item providing server 20. Normally, there is only one target item ID sent. A plurality of target item IDs may be sent.

In a step S105, the control section 205 of the item providing server 20 receives the target item ID via the sending and receiving section 204, and detects a base item ID equal to the target item ID by referring to the recommendation information store section 203. The control section 205 reads out associated item IDs and recommendation ranks corresponding to the detected base item ID, and combines them to make recommendation information for indication before sending the recommendation information to the terminal device 30.

According to the example of the stored contents in the recommendation information store section 203 in FIG. 5, when the target item ID is “ItemID-1”, the read-out is given of associated item IDs “ItemID-1000”, “ItemID-1020”, and “ItemID-1035” and their recommendation ranks “1”, “2”, and “3” corresponding to the base item ID equal to the target item ID. Preferably, all the associated item IDs corresponding to the detected base item ID are read out. Only a prescribed number of the associated item IDs may be read out in order of rank from the highest.

The control section 205 reads out, from the item store section 202, item attribute information pieces of “title”, “creator”, “category”, and others which correspond to the read-out associated item IDs, and combines the associated item IDs, the item attribute information pieces, and the recommendation ranks to make recommendation information for indication. The control section 205 sends the made recommendation information to the terminal device 30. In the case of a plurality of target item IDs, the control section 205 sends recommendation information pieces corresponding to the target item IDs respectively.

In a step S106, the terminal device 30 receives the recommendation information sent from the item providing server 20 by the step S105 and forces the indication device to indicate the received recommendation information as information about a list of associated items in a format such as shown in FIG. 13. According to the example of FIG. 13, items are music contents, and recommendation ranks, tune names (titles), artist names (creators), and genres (categories) are indicated.

The user monitors the picture on the indication device. If there is an item which the user desires to use, the user actuates the input device to choose an indication place corresponding to the desired item. In the case where items are, for example, music pieces, the user chooses a music piece which the user desires to play back by clicking via the mouse or others or by putting a mark in a check box on the left side and then pressing a “play” button. There are indicated an “indicate detailed information” button for indicating detailed information about the chosen music piece and a “quit” button for ending the current operation.

A button for purchasing an item, a button for indicating item information except the recommendation information, and a button for designating a keyword and indicating items corresponding to the designated keyword may be indicated although they are not shown in the example of FIG. 13. In this case, a command from the user which responds to button selection is received, and a process corresponding to the received command is done. While the item IDs in the recommendation information are not indicated on the indication device, the terminal device 30 stores and manages the item IDs corresponding to the items indicated on the indication device.

In a step S107, the terminal device 30 decides whether or not a request for the use of an item from the user is inputted via the input device. The item use request may be representatively an item purchasing request, and may contain at least one of various requests such as a request for the playback of the item, a request for the preview of the item, a request for the indication of detailed information of the item, and a request for the registration of evaluation information (evaluation value) regarding the item.

When the item use request is inputted (yes), advance to a step S109 is done. Otherwise (no), advance to a step S108 is done. In the step S108, the terminal device 30 decides whether or not an operation ending command from the user is inputted via the input device. When the operation ending command is inputted (yes), the current process is ended. Otherwise (no), return to the step S107 is done and the process is repeated.

When an item use request is inputted, the terminal device 30 sends a message of an item use request to the item providing server 20 in a step S109. This message contains the user ID of the user who is using the terminal device 30 and the item ID of the item designated by the user. A use time information piece representing the date of sending the use request may be contained in the message. Depending on the type of the use request, a necessary parameter (for example, an evaluation information piece) is contained in the message. In the case where the user desires to use a plurality of items at once, the item IDs of the items may be contained in one use request message. Alternatively, a plurality of use request messages may be sent for item IDs respectively.

In a step S110, when the sending and receiving section 204 of the item providing server 20 receives the use request message for an item from the terminal device 30, the control section 205 checks whether or not the user ID in the use request message agrees with one of user IDs in the user managing section 201. When the user ID in the use request message agrees with one of user IDs in the user managing section 201, the control section 205 performs a process of providing the designated item to the user who is using the terminal device 30.

For example, in the case where the item to be provided is digital contents, the control section 205 reads out the item body corresponding to the item ID in the use request message before sending the read-out item body to the terminal device 30 via the sending and receiving section 204. When the item is a good (a commodity), the control section 205 performs, for example, a delivery process of sending information of a delivery request to a system of a delivery enterprise. At this time, the control section 205 performs a charging process if necessary. In the case where detailed information about the item is requested, the control section 205 reads out, for example, the corresponding “description information” piece from the item store section 202 and sends it to the terminal device 30. When the user ID in the use request message agrees with none of user IDs in the user managing section 201, the control section 205 sends, to the terminal device 30, a message for urging the user to perform an entrance process to newly register the ID of the user in the user managing section 201.

In a step S111, the sending and receiving section 204 of the item providing server 20 sends the item use request message which has come from the terminal device 30 to the information selecting device 10, and hence relays it.

Next, in a step S112, the control section 110 of the information selecting device 10 receives the item use request message via the sending and receiving section 109 and stores the item use information in the use history store section 102. In a step S113, the control section 110 sends a message, which indicates that storing the item use information has ended, to the item providing server 20 via the sending and receiving section 109.

Next, in a step S114, the control section 205 of the item providing server 20 receives the message, which indicates that storing the item use information has ended, via the sending and receiving section 204, and sends it to the terminal device 30 via the sending and receiving section 204. When receiving the message, the terminal device 30 repeats the process from the step S107. The above is the operation of the whole of the system which occurs when the user uses an item.

According to the present embodiment of this invention, in the step S104, the terminal device 30 sends a message for requesting recommendation information to the item providing server 20. In the step S105, the item providing server 20 sends the recommendation information to the terminal device 30. This method may be replaced by another method. For example, the terminal device 30 may send a message for requesting recommendation information to the information selecting device 10 directly or via the item providing server 20, and the information selecting device 10 may send the recommendation information to the terminal device 30 directly or via the item providing server 20. In this case, the recommendation information store section 203 can be omitted from the item providing server 20.

According to the present embodiment of this invention, in the step S111, the item providing server 20 relays the item use information (message for requesting use of the item). This method may be replaced by another method. For example, at the same time as that of sending the use request message in the step S109 or at a suitable timing, the terminal device 30 may send the item use information directly to the information selecting device 10. In the step S113, the information selecting device 10 may send the recommendation information to the item providing server 20 or the terminal device 30. For example, information about items associated with the item ID in the use request message may be sent as the recommendation information.

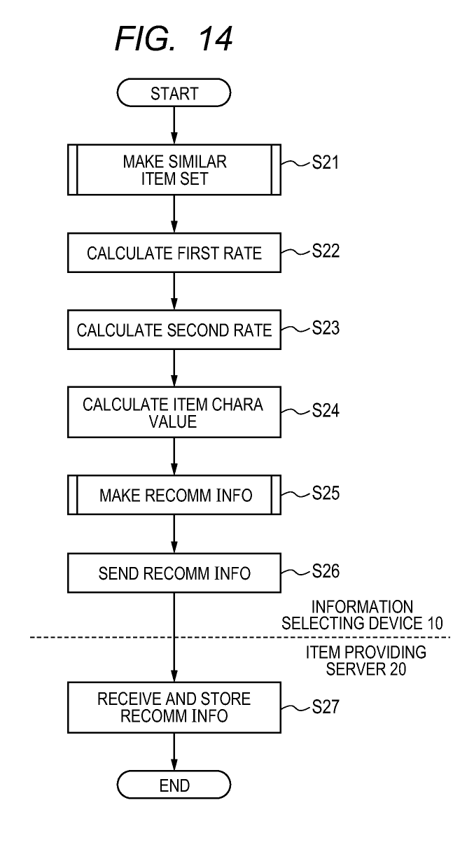

A description will be given of processing operation of the information selecting device 10. First, with reference to a flowchart in FIG. 14, a description will be given of operation in which the information selecting device 10 makes and sends recommendation information, and the item providing server 20 receives it.

When the control section 110 of the information selecting device 10 gives an operation starting command to the similar item set making section 104 at a prescribed timing, the process is started. One of various conditions may be used as the prescribed timing. A prescribed time interval such as every 12 hours or every 24 hours may be used. The time interval may vary in a manner such that every 3 hours will be for Monday to Friday and every 6 hours will be for Saturday, and every 12 hours will be for Sunday. The time interval may vary depending on the season in a manner such that the time interval will be shorter for summer and longer for winter.

The prescribed timing may be a timing at which the use request message (the use information) has been received a prescribed number of times. In this case, the prescribed number of times may be once so that recommendation information will be made upon every reception of the use information. Furthermore, the recommendation information may be made each time recommendation information is requested by the terminal device 30 or the item providing server 20. In the following description, a set of base items being objects for which recommendation information should be made will be called a base item set.

First, in a step S21 of FIG. 14, the similar item set making section 104 calculates the degrees of similarity between each of items in the base item set and other items by using use histories in the use history store section 102, and selects items (item IDs) corresponding to higher ones among the calculated degrees of similarity and makes the selected items into a similar item set for each item in the base item set.

Next, in a step S22, with respect to a first set being an item set having items in the similar item set for each base item which is made by the step S21, the first rate calculating section 105 calculates a first rate equal to the ratio of the number of items accorded with the recommended item conditions in the recommended item condition store section 103 to the number of all the items.

Subsequently, in a step S23, the second rate calculating section 106 makes a second set being an item set containing items except those in the first set. With respect to the second set, the second rate calculating section 106 calculates a second rate equal to the ratio of the number of items accorded with the recommended item conditions in the recommended item condition store section 103 to the number of all the items.

Next, in a step S24, the item characteristic value calculating section 107 calculates an item characteristic value representing the strength of the relation between each base item and the recommended item conditions.

Next, in a step S25, the item selecting section 108 selects items associated with each base item by using the item characteristic value and the similar item set to make recommendation information. The recommendation information is designed so that the item ID of the base item, the item IDs of the associated items, and the recommendation ranks are made in correspondence with each other as in the data format described regarding the recommendation information store section 203 of the item providing server 20.

Next, in a step S26, the control section 110 sends the recommendation information, which has been made by the step S25, to the item providing server 20 via the sending and receiving section 109.

Finally, in a step S27, the control section 205 of the item providing server 20 receives the recommendation information via the sending and receiving section 204 and stores it into the recommendation information store section 203 in the format of FIG. 5. In the step S105, the item providing server 20 makes recommendation information for indication by using the stored recommendation information. In the case where old recommendation information is already in the recommendation information store section 203, the old recommendation information is erased before the new recommendation information is stored thereinto. The date of the storing may be stored as a version information piece so that a plurality of versions of recommendation information may be simultaneously stored.

The steps S26 and the step S27 are omitted in the case where as mentioned above, the terminal device 30 sends the recommendation information request message to the information selecting device 10 directly or via the item providing server 20, and the information selecting device 10 sends the recommendation information to the terminal device 30 directly or via the item providing server 20, and the recommendation information store section 203 is omitted from the item providing server 20.

When the information selecting device 10 sends the recommendation information to the terminal device 30 directly or via the item providing server 20, the control section 110 of the information selecting device 10 makes a list of item information pieces based on the recommendation information inclusive of the associated item IDs, the item attribute information pieces, and the information pieces of the recommendation ranks while referring to the item attribute store section 101 and the item selecting section 108 in a method similar to that mentioned regarding the step S105. Then, the control section 110 sends the item information list to the terminal device 30 directly or via the item providing server 20.

In the case of handling items of such character that a user does not use (purchase) a same item plural times in principle as in service (download type service) in which the terminal device 30 stores contents downloaded from the item providing server 20 and the stored contents are allowed to be repetitively played back, it is preferable that the user ID of the user who is using the terminal device 30 is contained in the recommendation information request message in addition to the target item ID. Furthermore, it is preferable that at the time of sending the recommendation information from the information selecting device 10 to the terminal device 30 directly or via the item providing server 20, the control section 110 of the information selecting device 10 excludes items used in the past by the user with the user ID in the recommendation information request message and makes a list of item information pieces based on the recommendation information while referring to the item attribute store section 101, the item selecting section 108, and the use history store section 102. In this case, the control section 110 sends the made list.

In the case where the information selecting device 10 sends the recommendation information to the terminal device 30 via the item providing server 20 so that the information selecting device 10 sends the recommendation information to the item providing server 20 first, the item providing server 20 may implement a process of making a list of item information pieces based on the received recommendation information before sending the item information list to the terminal device 30.

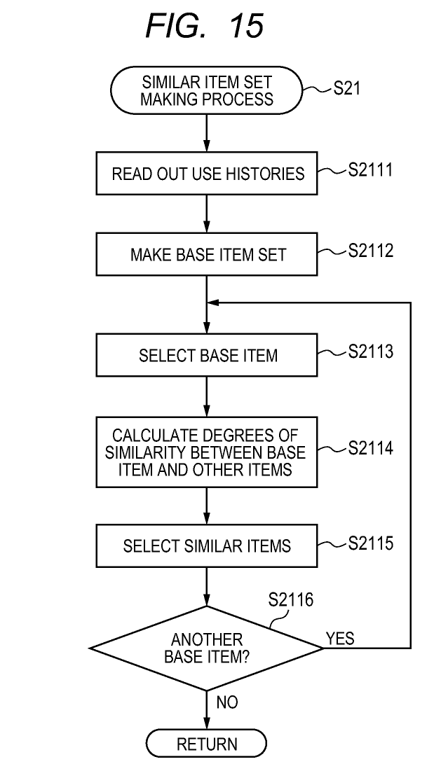

The process of making the similar item set (the step S21) by the information selecting device 10 will be described below in detail with reference to a flowchart of FIG. 15.

In a step S2111 of FIG. 15, the similar item set making section 104 reads out the use histories from the use history store section 102. All the use histories may be read out. Only ones of the use histories that meet prescribed conditions may be read out. For example, the read-out may be done of use histories satisfying the conditions that the use time information of the use histories is in a prescribed range, for example, the use time is in the past 4 months or the difference between the use time and the present time is between 3 days and 30 days.

For each item, the read-out may be done of a prescribed number of use histories or less use histories arranged in order of use time from the newest. For example, in the case where the prescribed number is 20, the read-out is done of 20 use histories in order of use time from the newest for an item corresponding to the number of times of use being 20 or more, and the read-out is done of all use histories for an item corresponding to the number of times of use being less than 20. In this case, a similar item set can be made even for an item which corresponds to a small use frequency and has not been used recently.

A set of the item IDs contained in the use histories read out by this step is denoted by σ, and the number of different item IDs (the number of different items) is denoted by Ms, and the number of different user IDs (the number of different users) is denoted by Us.

Next, in a step S2112, the similar item set making section 104 makes a base item set. In the case where recommendation information is made each time a use request message or a recommendation information request message is received from the terminal device 30 or the item providing server 20 as mentioned above, an item ID or IDs in the received message is placed in the base item set. Normally, each of the use request message and the recommendation information request message has only one item ID. Sometimes, each of the use request message and the recommendation information request message has a plurality of item IDs. In the case where recommendation information is made at a timing defined by prescribed time intervals, the item set σ made by the step S2111 is handled as a base item set. In this case, a similar item set is made for each of the item IDs in the use histories satisfying the prescribed conditions.

Next, in a step S2113, the similar item set making section 104 selects, from the base item set, one item which has not yet been processed. The selected item is an object to be processed, and is called the base item x.

In a step S2114, the similar item set making section 104 calculates the degree of similarity between the base item x and another item y (yεσ, x≠y) in the item set σ by using the use histories read out by the step S2111.

Specifically, a set of users who have used the item x is denoted by I[x], and a set of users who have used the item y is denoted by I[y]. The number of users who have used both the item x and the item y is denoted by |I[x]∩I[y]|, and the number of users who have used at least one of the item x and the item y is denoted by |I[u]∪I[y]|. The user number |I[x]∩I[y]| may be labeled as the calculated similarity degree after being calculated. Alternatively, the degree W[x][y] of similarity between the item x and the item y can be calculated by using a Jaccard coefficient as expressed in the following equation.

$$W [ x ] [ y ] = \frac{\vert I [ x ] ⋂ I [ y ] \vert}{\vert I [ x ] ⋃ I [ y ] \vert}$$

In the case where information about the number of times of use or information about the evaluation (the evaluation value) made by the user for the item can be obtained from the use histories read out by the step S2111, the degree of similarity may be calculated by using a cosine measure or a Pearson product-moment correlation coefficient. For example, the evaluation value or the number of times of use of the item x by a user i is denoted by E[x][i], and the evaluation value or the number of times of use of the item y by the user i is denoted by E[y][i]. The degree W[x][y] of similarity between the item x and the item y can be calculated by using a cosine measure as expressed in the following equation.

$$W [ x ] [ y ] = \frac{{\sum }_{i = 1}^{Us} E [ x ] [ i ] \times E [ y ] [ i ]}{\sqrt{{\sum }_{i = 1}^{Us} {E [ x ] [ i ]}^{2}} \sqrt{{\sum }_{i = 1}^{Us} {E [ y ] [ i ]}^{2} }}$$

where Us denotes the number of different user IDs in the use histories read out by the step S2111.

The similarity degree W[x][y] may be calculated by using a Pearson product-moment correlation coefficient as expressed in the following equation.

$$W [ x ] [ y ] = \frac{{\sum }_{i ∈ Ic [ x ] [ y ]} ( E [ x ] [ i ] - Ea [ x ] ) ( E [ y ] [ i ] - Ea [ y ] )}{\sqrt{{\sum }_{i ∈ Ic [ x ] [ y ]} {( E [ x ] [ i ] - Ea [ u ] )}^{2}} \sqrt{{\sum }_{i ∈ Ic [ x ] [ y ]} {( E [ x ] [ i ] - Ea [ y ] )}^{2}}}$$

where Ic[x] [y] denotes a set of users who have used both the item x and the item y, and Ea[x] denotes an average of the evaluation values or the numbers of times of use of the item x by a user i in the user set Ic[x] [y], and Ea[y] denotes an average of the evaluation values or the numbers of times of use of the item y by the user i. The similarity degree W[x][y] may be calculated by using the Euclidean distance or another distance between E[x][i] and E[y][i].

According to another example, multivariate statistical analysis such as principal component analysis or mathematical quantification class 3 is applied to a matrix having elements formed by the numbers of times of use or the evaluation values E[x][i] (i=1˜Us, x=1˜Ms) of the item x by the user i to generate a vector reduced in number of dimensions, and the similarity degree is calculated by using the cosine measure or the Euclidean distance. Any other methods may be used as long as they provide indexes each representing the degree of similarity between the two items.

Next, in a step S2115, the similar item set making section 104 selects similar items high in degree of similarity with the base item x. Specifically, items having the degrees of similarity with the base item x which are equal to or greater than a threshold value (first prescribed value) are selected from the item set σ, and the selected items are labeled as the similar items. A prescribed number (first prescribed number) of other items or less other items may be selected in order of degree of similarity with the base item x from the highest, and the selected items may be labeled as the similar items.

For example, in the case where the degrees of similarity are calculated as numerical values equal to or greater than 0, when the number of items having the degrees of similarity with the base item x which are greater than 0 is less than a prescribed number, all the items having the calculated similarity degrees greater than 0 are labeled as the similar items. On the other hand, when the number of items having the calculated similarity degrees is equal to or greater than the prescribed number, the prescribed number of items are selected in order of similarity degree from the highest as the similar items.

Among other items having degrees of similarity with the base item x which are equal to or greater than a given value, items, the number of which does not exceed the prescribed number, may be selected in order of similarity degree from the highest. In this case, the selected items are labeled as the similar items. The threshold value for the similarity degree may be adjusted on a base item-by-base item basis and similar items may be selected in response to the adjusted threshold value so that a prescribed number of similar items or more similar items can be obtained.

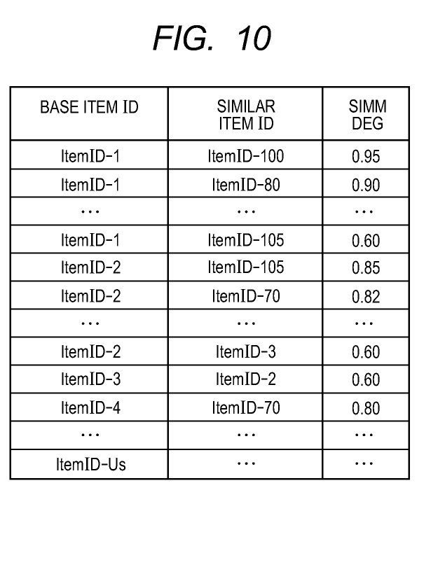

The similar item set making section 104 stores the item ID of the base item x, the item IDs of the selected similar items, and the degrees of similarity therebetween in a memory area therein while relating them with each other in a format such as that in FIG. 10.

With reference to FIG. 10, the similar items are stored in order of similarity degree from the highest with respect to each base item. The number of similar items may depend on the base item x, or may be constant. A set of the similar items (set of the item IDs of the similar items) with respect to the base item x which are provided by this step is denoted by ω[x].

Next, in a step S2116, the similar item set making section 104 decides whether or not another base item can be selected. When an item which has not yet been processed is in the base item set made by the step S2112, the result of the decision is “yes”. On the other hand, when an unprocessed item is absent, the result of the decision is “no”. In the case where the decision result is “yes”, return to the step S2113 is done to repeat the process. In the case where the decision result is “no”, the similar item set making process is ended.

In the above description, the information selecting device 10 (the similar item set making section 104) calculates the similarity degrees. Instead of the information selecting device 10, another device may calculate the similarity degrees which will be used for making the similar item sets.

A detailed description will be given of the first rate calculation process by the step S22. With respect to each item in the base item set, the first rate calculating section 105 makes a first set of items by using the related similar item set. For the first set, the first rate calculating section 105 calculates a first rate R1 equal to the ratio of the number of items accorded with the recommended item conditions to the number of all the items, and stores the calculated first rate R1 in a memory area therein. For the simplicity of description, a process about one base item x in the base item set will be described. In the case where there is a plurality of base items, similar processes are performed for the respective base items.

As mentioned above, the first rate calculating section 105 makes a first set of items from the similar item set with respect to the base item x and made by the similar item set making process in the step S21. For the first set, the first rate calculating section 105 calculates a rate equal to the ratio of the number of items accorded with the recommended item conditions to the number of all the items, and labels the calculated rate as the first rate R1.

All items in the similar item set may be made into the first set. Ones of items in the similar item set may be made into the first set. In the latter case, a prescribed number of items which is less than the number of all items in the similar item set are selected at random, or selected in order of similarity degree from the highest, and the selected items are made into the first set. The foregoing prescribed number may be equal to the number of items selected by the recommendation information making process by the step S25.

Next, the first rate calculating section 105 counts the number of the items in the first set, and labels the counted number as NA. The first rate calculating section 105 collates the item IDs in the first set with the recommended item conditions in the recommended item condition store section 103 which are shown in one of FIGS. 9(a)-9(d), and counts the number of items (item IDs) accorded with the recommended item conditions. Then, the first rate calculating section 105 labels the counted number as NB.

In the case where the recommended item conditions use condition types as in the format of FIG. 9(c) or FIG. 9(d), it is good to count the item IDs accorded with the recommended item conditions while referring to the item attribute store section 101. In the case where the condition type is “7” being the rank about the number of times of use or “8” being the number of times of use, the memory area in the recommended item condition store section 103 stores item IDs (a set of item IDs) accorded with the conditions, and the item ID set and the first set are compared and item IDs in agreement are counted.

The first rate calculating section 105 divides the number NB by the number NA to calculate a division result value (NB÷NA), and labels the division result value as a first rate R1. In the case where the recommended item conditions are stored with the format of FIG. 9(c) as previously mentioned and the degree of agreement (conformity) can be calculated, the first rate may be calculated by using the degree of agreement. Specifically, the degrees of agreement are calculated for the respective items in the first set, and the representative value (for example, the mean, the median, or the mode) among the calculated degrees is labeled as the first rate. Normalization may be done to confine each agreement degree in the rage of from 0 to 1. This case is good since the representative value is held in the range of from 0 to 1 also.

A detailed description will be given of the second rate calculation process by the step S23. The second rate calculating section 106 uses one of below-mentioned methods, and thereby performs the following actions. With respect to each item in the base item set, the second rate calculating section 106 makes a second set being a set of items except the items in the first set. For the second set, the second rate calculating section 106 calculates a second rate R2 equal to the ratio of the number of items accorded with the recommended item conditions to the number of all the items.

It is said that the degrees of similarity of the items in the second set with the base item are not so high as compared with those of the items in the first set. The second rate calculating section 106 stores the item ID of the base item and the second rate in a memory area therein while making them in correspondence. For the simplicity of description, a process about one base item x in the base item set will be described. In the case where there is a plurality of base items, similar processes are performed for the respective base items.

A first method of the second set making process by the step S23 will be described below. In the first method, a comparison item set containing items except the base item x is made, and the degrees of similarity between each item in the comparison item set and other items are calculated. Items having high calculated similarity degrees are selected, and the selected items are made into a candidate set for each item in the comparison set. Then, a second set is generated from the candidate sets for the respective items in the comparison set.

The calculation of the similarity degrees and the selection of items having high calculated similarity degrees can be implemented in a way similar to the operation of the similar item set making section 104. The comparison item set has only one item or a plurality of items. Items for the comparison item set may be selected at random. For the comparison item set, ones may be selected from items having the degrees of similarity with the base item x which are equal to or less than a prescribed value. In the case where the comparison item set has a plurality of items, one of the items therein may be the base item x. For example, when the base item set has a plurality of items, the base item set may be labeled as the comparison item set.

Items for the comparison item set are selected so that the second set will contain items except the items in the first set. Thus, the second set is made to be not a subset of the first set. It is sufficient that even when a candidate set for a certain item is a subset of the first set, another candidate set is not a subset of the first set. Thus, one or ones of the items in the second set may be in the first set.

The method of generating the second set from the candidate sets includes a method of labeling a union of the candidate sets as the second set. In addition, there is a method of selecting, from a union of the candidate sets, a prescribed number of items in order of degree of similarity with each item in the comparison item set from the highest, and making the selected items into the second set. Items having similarity degrees equal to or higher than a prescribed value may be selected from the union of the candidate sets before the selected items are made into the second set.

Next, a second method of the second set making process by the step S23 will be described below. In the second method, the degree of similarity between the base item x and each of other items is calculated. Then, items lower in similarity degree than the items in the similar item set are selected, and the selected items are made into the second set.

The calculation of the similarity degrees can be performed in a method similar to the operation of the similar item set making section 104. In the case where the similar item set is made by using the threshold value (the first similarity threshold value) regarding the similarity degree in the step S2115, items having similarity degrees less than the first similarity threshold value are selected.

It is good to select a prescribed number of items having similarity degrees less than the first similarity threshold value in order of similarity degree from the highest or the lowest. Alternatively, a prescribed number of items may be selected at random from items having similarity degrees less than the first similarity threshold value. A second similarity threshold value less than the first similarity threshold value and a third similarity threshold value less than the second similarity threshold value may be prepared. In this case, items having similarity degrees between the second similarity threshold value and the third similarity threshold value are selected.

In the case where a prescribed number of items or less items are selected in order of similarity degree from the highest in the similar item set making process by the step S2115, a first rank value greater than the number of selected items (the number of elements in the similar item set) is prepared. Then, the items are sorted so that an item having a higher similarity degree will have a smaller rank value. Thereafter, items having rank values equal to or greater than the first rank value are selected.

For example, in the case where the number of elements constituting the similar item set is 20 and the items are sorted in order of similarity degree from the highest, it is good to select items having rank values equal to or later than the 21-st rank. In this case, from items having rank values equal to or later than the 21-st rank, a prescribed number of items may be selected at random or in order of similarity degree from the highest or the lowest. A second rank value greater than the first rank value may be prepared. In this case, items having rank values between the first rank value and the second rank value are selected. In the above-mentioned example, when the second rank value is set to the 40-th rank, it is good to select items having rank values between the 21-st rank and the 40-th rank.

A third method of the second set making process by the step S23 will be described below. In the third method, a prescribed number of item IDs are selected at random from the item IDs in the item attribute store section 101 or the item IDs in the use history store section 102, and the selected item IDs are made into the second set. Also in this case, the second set is made to be not a subset of the first set.

After making the second set in one of the above-mentioned methods, the second rate calculating section 106 counts the number NE of elements of the second set. The number of elements of the second set is equal to or different from that of the first set. With respect to the second set, the second rate calculating section 106 collates the item IDs in the second item set with the recommended item conditions in the recommended item condition store section 103 which are shown in one of FIGS. 9(a)-9(d), and counts the number NF of items (item IDs) accorded with the recommended item conditions.

The second rate calculating section 106 divides the number NF by the number NE to calculate a division result value (NF÷NE), and labels the division result value as a second rate R2. In the case where the recommended item conditions are stored with the format of FIG. 9(c) or 9(d) as previously mentioned and the degree of agreement (conformity) can be calculated, the second rate may be calculated by using the degree of agreement. Specifically, the degrees of agreement are calculated for the respective items in the second set, and the representative value (for example, the mean, the median, or the mode) among the calculated degrees is labeled as the second rate. Normalization may be done to confine each agreement degree in the rage of from 0 to 1. This case is good since the representative value is held in the range of from 0 to 1 also.

A detailed description will be given of the item characteristic value calculation process by the step S24. The item characteristic value calculating section 107 uses one of below-mentioned methods, and thereby performs the following actions. With respect to each base item in the base item set, the item characteristic value calculating section 107 calculates an item characteristic value representing the strength of the relation between the base item and the recommended item conditions. The item characteristic value calculating section 107 stores the base item IDs and the item characteristic values in a memory area therein while making them in correspondence. For the simplicity of description, a process about one base item x in the base item set will be described. In the case where there is a plurality of base items, similar processes are performed for the respective base items.

A first method of the item characteristic value calculation process will be described below. In the first method, the first rate R1 calculated by the step S22 is labeled as the item characteristic value for the base item x. In the case where the first method is used, the second rate calculating section 106 and the step S23 can be omitted. The first method is the smallest in processing amount, and is simple.

A second method of the item characteristic value calculation process divides the first rate R1 by the second rate R2 to calculate a division result value (R1÷R2), and labels the division result value as the item characteristic value for the base item x. In this case, the item characteristic value relatively represents the strength of the relation between the base item x and the recommended item conditions while a comparison item is regarded as a reference.

In the first method of the item characteristic value calculation process, the item characteristic value is greater as the recommended item conditions in the recommended item condition store section 103 correspond to more items. The item characteristic value is smaller as the recommended item conditions in the recommended item condition store section 103 correspond to less items. Thus, the item characteristic value sensitively depends on the way of setting the recommended item conditions.

In the second method of the item characteristic value calculation process, since both the rates R1 and R2 are used, the item characteristic value is less affected by a variation in the recommended item conditions. Especially, in the case where the second rate R2 is calculated by using data of many items, the item characteristic value is much less affected by a variation in the recommended item conditions. Therefore, it is possible to accurately quantify the strength of the relation between the base item x and the recommended item conditions.

A third method of the item characteristic value calculation process subtracts the second rate R2 from the first rate R1 to calculate a subtraction result value (R1−R2), and labels the subtraction result value as the item characteristic value. In this case, the item characteristic value relatively represents the strength of the relation between the base item x and the recommended item conditions while a comparison item is regarded as a reference. Since the item characteristic value is much less affected by the way of setting the recommended item conditions as in the second method, it is possible to accurately quantify the strength of the relation between the base item x and the recommended item conditions.

The item characteristic value calculated in one of the above-mentioned methods is greater as the relation between the base item x and the recommended item conditions is stronger. The item characteristic value monotonically increases as the first rate R1 increases.

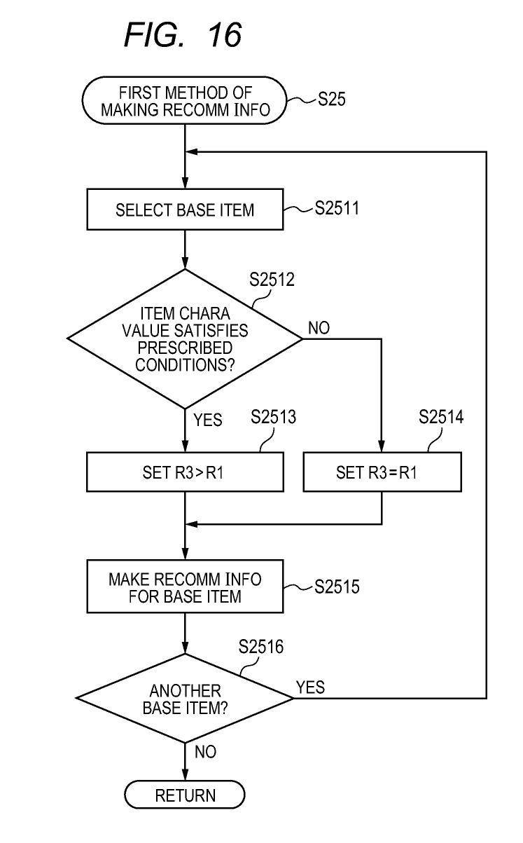

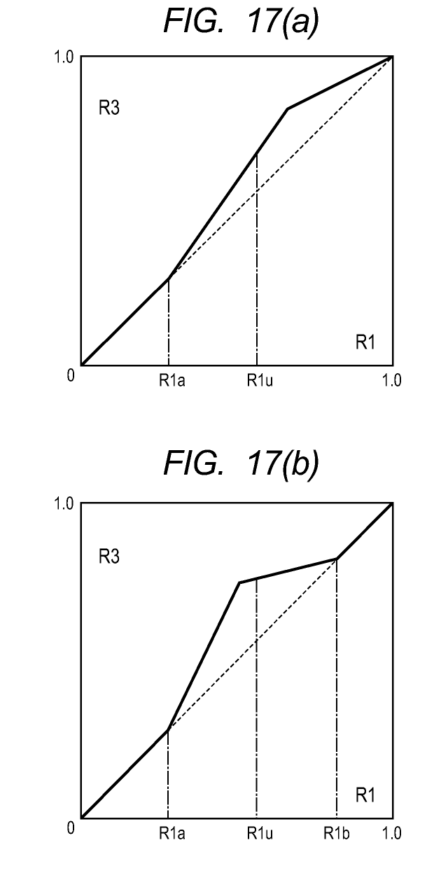

A detailed description will be given of the recommendation information making process by the step S25. A first method of the recommendation information making process will be described below with reference to a flowchart in FIG. 16.

In a step S2511 of FIG. 19, the item selecting section 108 selects, from the base item set, an item to be processed (a base item x). Specifically, the base item IDs and the similar item sets are stored in the memory area in the similar item set making section 104 during the similar item set making process by the step S2115. Thus, the item selecting section 108 selects, from the item IDs in the memory area in the similar item set making section 104, one base item ID which has not yet been processed.

Next, in a step S2512, the item selecting section 108 decides whether or not the item characteristic value of the base item selected by the step S2511 satisfies prescribed item characteristic value conditions. When the result of the decision is “yes”, advance to a step S2513 is done. When the result of the decision is “no”, advance to a step S2514 is done.

Specifically, the item selecting section 108 reads out the item characteristic value α corresponding to the base item x from the memory area in the item characteristic value store section 107, and decides whether or not the read-out item characteristic value α satisfies the prescribed item characteristic value conditions. The prescribed item characteristic value conditions may use decision conditions A as “α>θ1”, where θ1 denotes a prescribed threshold value. The decision conditions A mean that the user characteristic value α is greater than the prescribed threshold value θ1. When the decision conditions A are used, it is possible to detect that the strength of the relation between the base item x and the recommended item conditions is equal to or greater than a certain degree.

The decision conditions A may be replaced by decision conditions B as “θ2>α>θ1”, where θ2 denotes a prescribed threshold value greater than the prescribed threshold value θ1 (θ2>θ1). When the decision conditions B are used, it is possible to detect that the strength of the relation between the base item x and the recommended item conditions is equal to or greater than a certain degree but is not extremely great.

The decision can be made by directly using the first rate R1 as mentioned regarding the first method of the item characteristic value calculation process. This method is simple but may cause the following fact. In the case where the recommended item conditions in the recommended item condition store section 103 vary, it is not good to set the threshold values θ1 and θ2 as fixed values and the threshold values θ1 and θ2 may need to be adjusted in accordance with the variation in the recommended item conditions. On the other hand, when the second or third method of the item characteristic value calculation process is used, the necessity for the adjustment of threshold values θ1 and θ2 can be reduced.

In the step S2513, the item selecting section 108 sets a rate in number of items accorded with the recommended item conditions with respect to a set of items to be placed in the recommendation information. This rate is referred to as a third rate R3.

In the step S2513, the third rate R3 is chosen to be greater than the first rate R1 calculated by the first rate calculating section 105 but smaller than 1. The reason for making the third rate R3 greater than the first rate R1 is that more items accorded with the recommended item conditions (the sales policy of the seller) are placed in the recommendation information outputted on the basis of the base item.

The first rate R1 is of the number of items accorded with the recommended item conditions in the recommendation information (the normal recommendation information) that is made in accordance with the degrees of similarities between items without consideration of the recommended item conditions. Thus, as compared with the normal recommendation information, items are accorded with the recommended item conditions at a higher rate.

The reason for making the third rate R3 smaller than 1 is as follows. If all items in the recommendation information are accorded with the sales policy of the seller, some user may susceptibly sense a common factor among the recommended items and interpret the common factor as a high-pressure selling or aggressive peddling attitude of the seller. Such a risk should be reduced.

A first method of the third rate setting process is to set the third rate R3 to a same value for all items corresponding to the result “yes” of the decision by the step S2512. For example, it is good that R3=0.8. In this case, the decision conditions B may be used, and the threshold value θ2 in the decision conditions B may be chosen so that the result of the decision by the step S2512 will not be “yes” for items corresponding to first rates R1 greater than 0.8.

A second method of the third rate setting process is to set the third rate R3 on the basis of the first rate R1. The second method will be described below with reference to FIGS. 17(a) and 17(b).

FIG. 17(a) shows the characteristic of the function for the conversion to the third rate R3 from the first rate R1 which is used in the case of use of the decision conditions A in the step S2512.

In FIG. 17(a), the abscissa denotes the first rate R1 while the ordinate denotes the third rate R3. Each of the first rate R1 and the third rate R3 takes a value in the range from 0 to 1. In FIG. 17(a), the broken line oblique at an angle of 45 degrees represents the case where the third rate R3 is set equal to the first rate R1, that is, the case where R3=R1. In addition, R1u denotes a value of the first rate R1 for the base item x. Furthermore, R1a denotes a value resulting from converting the threshold value θ1 for the item characteristic value of the base item x to the first rate R1.

In the characteristic of FIG. 17(a), when the first rate R1 is in the range of from 0 to the value R1a, the conversion function agrees with the broken line oblique at an angle of 45 degrees so that R3=R1. When the first rate R1 is in the range as “R1a<R1<1”, the third rate R3 is greater than the first rate R1 (R3>R1).

The value R1u that is the first rate R1 for the base item x subjected to the decision by the step S2512 is greater than the value R1a so that there is obtained the third rate R3 greater than the first rate R1 but smaller than 1. It should be noted that the base item x related to a first rate R1 of 1 corresponds to a third rate R3 of 1 also.

FIG. 17(b) shows the characteristic of the function for the conversion from the first rate R1 to the third rate R3 which is used in the case of use of the decision conditions B in the step S2512. In FIG. 17(b), R1b denotes a value resulting from converting the threshold value θ2 for the item characteristic value of the base item x to the first rate R1.

In the characteristic of FIG. 17(b), when the first rate R1 is in the range as “0≦R1≦R1a”, the conversion function agrees with the broken line oblique at an angle of 45 degrees so that R3=R1. When the first rate R1 is in the range as “R1a<R1<R1b”, the third rate R3 is greater than the first rate R1 (R3>R1). When the first rate R1 is in the range as “R1b≦R1≦1”, the third rate R3 is equal to the first rate R1 (R3=R1).

The value R1u that is the first rate R1 for the base item x subjected to the decision by the step S2513 is between the values R1a and R1b (R1a<R1u<R1b) so that there is obtained the third rate R3 greater than the first rate R1 but smaller than 1. According to each of the conversion functions in FIGS. 17(a) and 17(b), the third rate R3 increases as the first rate R1 increases, and there is no interval where the third rate R3 decreases as the first rate R1 increases.

The base item x related to the result “yes” of the decision by the step S2512 has the strength of the relation with the recommended item conditions which is equal to or greater than a certain degree. Therefore, as compared with an item related to the result “no” of the decision by the step S2512, it is not unnatural that many similar items accorded with the recommended item conditions are in the recommendation information. Thus, a user has only a small chance of feeling a high-pressure selling attitude of the seller and a good chance of gently making acceptance. Accordingly, by performing such a process, many items in line with the sales policy can be recommended in a manner such that the user can easily accept the presentation of the recommended items. By using the decision conditions B, it is possible to further reduce a risk of causing the user to feel a high-pressure selling attitude of the seller.

For the base item x related to the result “no” of the decision by the step S2512, the item selecting section 108 sets the third rate R3 equal to the first rate R1 in the step S2514. Thus, the number of items accorded with the recommended item conditions (the sales policy) is made to be not increased. This is for the following reason. The base item x related to the result “no” of the decision by the step S2512 has a not so strong relation with the recommended item conditions. Accordingly, when the number of items accorded with the recommended item conditions (the sales policy) is made to be not increased, there is a better possibility that the recommendation information can be accepted by the user.

Next, in a step S2515, the item selecting section 108 selects items to be placed in the recommendation information in response to the third rate R3. When the item number NR regarding the recommendation information is decided, the similar item set for the base item x is read out from the memory area in the similar item set making section 104. Then, (NR×R3) items accorded with the recommended item conditions are selected from the similar item set in order of similarity degree from the highest while the recommended item condition store section 103 is referred to. The selected items are in a first group.

Next, (NR×(1−R3)) items not accorded with the recommended item conditions are selected from the similar item set in order of similarity degree from the highest. The selected items are in a second group. The items in the first and second groups are ranked for recommendation in order of similarity degree from the highest to make recommendation information. To enable NR items to be selected, the first prescribed number and the first similarity threshold value used in the step S2115 are chosen to make a similar item set having a sufficient number of items in advance. Adjustment may be done so that at least one item being in the similar item set and not accorded with the recommended item conditions will be placed in the recommendation information.

When the item number NR regarding the recommendation information is not decided, the following process is performed. First, the number NX of items in the similar item set which are accorded with the recommended item conditions is counted, and the number NY of items in the similar item set which are not accorded with the recommended item conditions is counted.

Next, the value of (NX/R3) and the value of (NY/(1−R3) are compared. When the value of (NX/R3) is smaller, all the NX items in the similar item set which are accorded with the recommended item conditions are selected. In addition, ((NX/R3)×(1−R3)) items in the similar item set which are not accorded with the recommended item conditions are selected in order of similarity degree from the highest. These selected items are placed in the recommendation information.

On the other hand, when the value of (NY/(1−R3)) is smaller, all the NY items in the similar item set which are not accorded with the recommended item conditions are selected. In addition, ((NY/(1−R3))×R3) items in the similar item set which are accorded with the recommended item conditions are selected in order of preference degree from the highest. These selected items are placed in the recommendation information. Adjustment may be done so that at least one item being in the similar item set and not accorded with the recommended item conditions will be placed in the recommendation information.

Next, in a step S2516, the item selecting section 108 decides whether or not another base item can be selected. When a base item which has not yet been processed is in the base item set, the result of the decision is “yes”. On the other hand, when a base item which has not yet been processed is absent, the result of the decision is “no”. In the case where the decision result is “yes”, return to the step S2511 is done to repeat the process. In the case where the decision result is “no”, the recommendation information making process by the step S25 is ended.

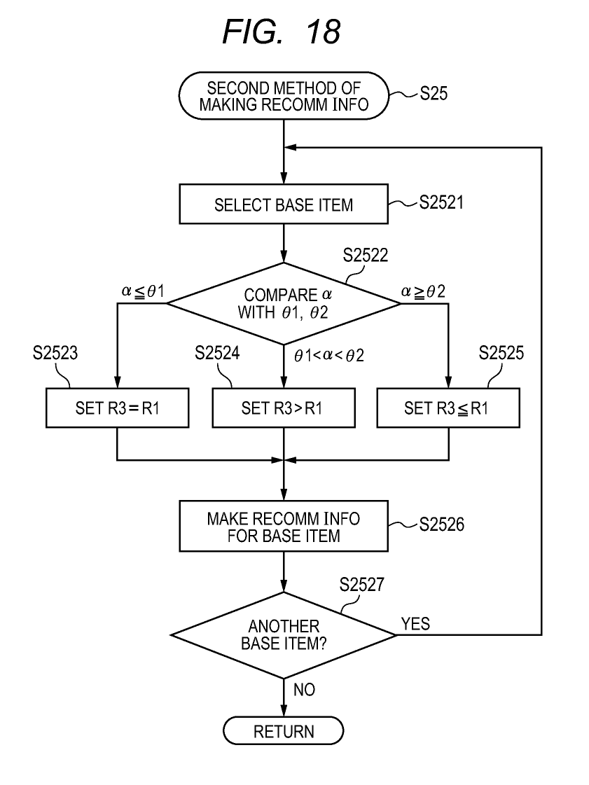

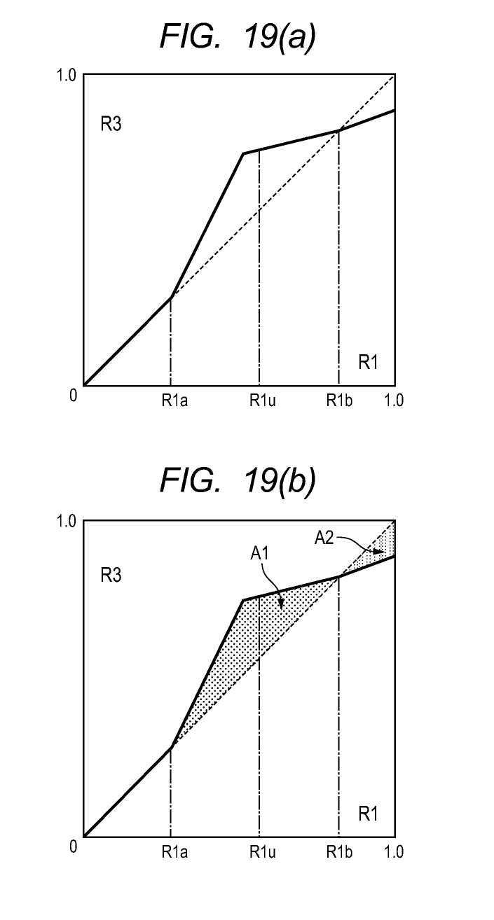

A second method of the recommendation information making process by the step S25 will be described below with reference to a flowchart in FIG. 18. A base item selecting process by a step S2521 in FIG. 18 is the same as that by the step S2511 in the first method.

In a step S2522, the item characteristic value α of the base item x and prescribed threshold values θ1 and θ2 are compared as about the decision conditions B in the step S2512 in the first method, where θ1<θ2. In the case of θ1<α<θ2, advance to a step S2524 is done. In the case of α<θ1, advance to a step S2523 is done. In the case of α≧θ2, advance to a step S2525 is done.

In the step S2524, a process similar to the process using the conversion function shown in FIG. 17(b) in the step S2513 is performed, and thereby a third rate R3 is set as a value greater than the first rate R1.

In the step S2523, the setting is done so that R3=R1 as in the step S2514 in the first method.

In the step S2525, the third rate R3 is set to a value equal to or less than the first rate R1. This method will be described with reference to FIGS. 19(a) and 19(b).

FIG. 19(a) shows a conversion function for calculating the third rate R3 on the basis of the first rate R1. The characters in the drawing are similar to those mentioned with reference to FIG. 17(b), and R1b denotes a value resulting from converting the threshold value θ2 for the item characteristic value of the base item x to the first rate R1.

When the first rate R1 is in the rage as 0≦R1≦R1a, the conversion characteristic agrees with the broken line oblique at an angle of 45 degrees so that R3=R1. When the first rate R1 is in the range as “R1a<R1<R1b”, the third rate R3 is greater than the first rate R1 (R3>R1). The process in the step S2525 is performed when α≧θ2, that is, when R1b≦R1≦1. In this case, R3≦R1.

The conversion characteristic in FIG. 19(a) differs in this portion from that in FIG. 17(b), and is characterized in that R3<R1 even when R1=1. Thus, the recommendation information for any base item is not occupied by items accorded with the sales policy at 100%. Therefore, the user less feels a common factor among the items in the recommendation information, and it is possible to further reduce a risk of causing the user to feel a high-pressure selling attitude of the seller.

In this process, the rate in number of items accorded with the sales policy is less than that in the normal recommendation information in the first-rate range of R1b≦R1≦1. However, if the first rates R1 for many base items are uniformly distributed and the area of the region below the solid line in FIG. 19(b) is greater than that of the region below the broken line oblique at an angle of 45 degrees, the average rate in number of items accorded with the sales policy and in the recommendation information for many base items is greater than the average rate in number of items accorded with the sales policy and in the normal recommendation information. Therefore, seller's aim for recommending items accorded with the sales policy to users is achieved. In the example of FIG. 19(b), the area of the triangle A1 surrounded by the solid lines and the broken line is greater than that of the triangle A2 so that the above-mentioned conditions are satisfied and seller's aim is achieved.

Subsequent steps S2526 and S2527 are the same as the steps S2515 and S2516 in the first method.

### Second Embodiment

A network system in a second embodiment of this invention is similar to that in the first embodiment thereof except for design changes mentioned hereafter.

The network system in the second embodiment of this invention includes an item providing server 20, one or more terminal devices 30 (30a, 30b, . . . 30n), and a network 40 which are the same as those in the first embodiment of this invention. The network system in the second embodiment of this invention may include a network 42 which is the same as that in the first embodiment of this invention. The network system in the second embodiment of this invention includes an information selecting device 10a instead of the information selecting device 10 (FIG. 1 or FIG. 2).

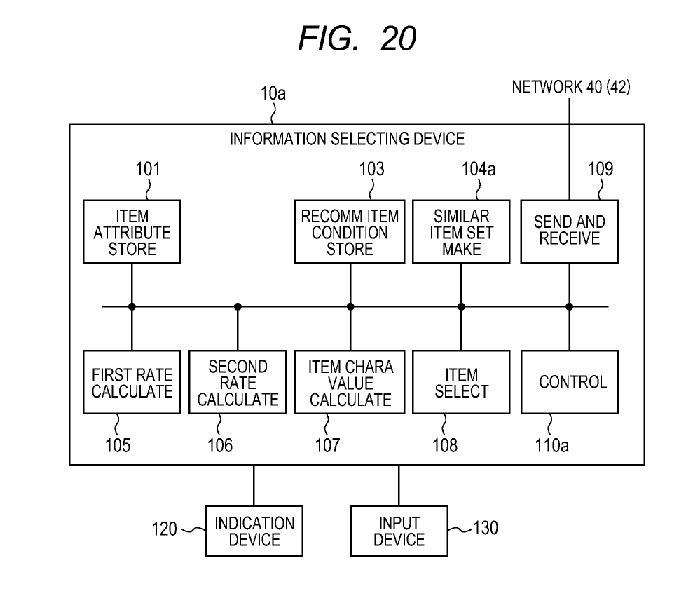

FIG. 20 is a block diagram showing the structure of the information selecting device 10a. The same elements in the information selecting device 10a as those in the information selecting device 10 (FIG. 6) are denoted by the same reference characters as those in FIG. 6, and detailed description thereof will be omitted hereafter.

As shown in FIG. 20, the information selecting device 10a includes an item attribute store section 101, a recommended item condition store section 103, a similar item set making section 104a, a first rate calculating section 105, a second rate calculating section 106, an item characteristic value calculating section 107, an item selecting section 108, a sending and receiving section 109, and a control section 110a. An indication device 120 and an input device 130 are connected to the information selecting device 10a. The indication device 120 serves to indicate necessary information to a manager about the information selecting device 10a. The input device 130 is, for example, a keyboard or a mouse operated by the manager.

The information selecting device 10a is similar to the information selecting device 10 except for the following points. The information selecting device 10a dispenses with the use history store section 102. The information selecting device 10a uses the similar item set making section 104a and the control section 110a instead of the similar item set making section 104 and the control section 110. The similar item set making section 104a calculates similarity degrees without the use of use histories, and then makes similar item sets in response to the calculated similarity degrees.

The information selecting device 10a may be formed by a general computer including a CPU, a RAM, a ROM, an HDD (hard disk drive), a network interface, and others. The general computer executes a program of implementing processes as mentioned later, and thereby functions as the information selecting device 10a.

The information selecting device 10a may be formed by a plurality of computers. For example, to disperse load, computers are assigned to one processing block of the information selecting device 10a and thereby dispersedly processing is implemented. According to another example, one processing block of the information selecting device 10a is implemented by one computer while another processing block thereof is implemented by another computer, so that dispersedly processing can be carried out.

It is unnecessary to store use histories in the information selecting device 10a. Thus, in the second embodiment of this invention, the steps S111 to S114 are omitted from the flowchart of FIG. 11 which shows the operation of the whole of the system. After the step S110 is implemented by the item providing server 20, return to the step S107 is done so that the terminal device 30 implements the step S107.

The control section 110a in the information selecting device 10a controls the other sections therein to perform, at a prescribed timing, a set of processes of making similar item sets, calculating first rates, calculating second rates, calculating item characteristic values, making recommendation information, and sending the recommendation information which are similar to the processes in the flowchart of FIG. 11.

The details of the similar item set making process in the second embodiment of this invention will be given later. The above prescribed timing in the second embodiment of this invention may be a timing at which a recommendation information request message from another device (a terminal device 30 or the item providing server 20) is received. The above prescribed timing may be a timing at which the control section 110a detects that an item attribute information piece is additionally stored in the item attribute store section 101, that an item attribute information piece in the item attribute store section 101 is changed, or that an item attribute information piece is erased from the item attribute store section 101.

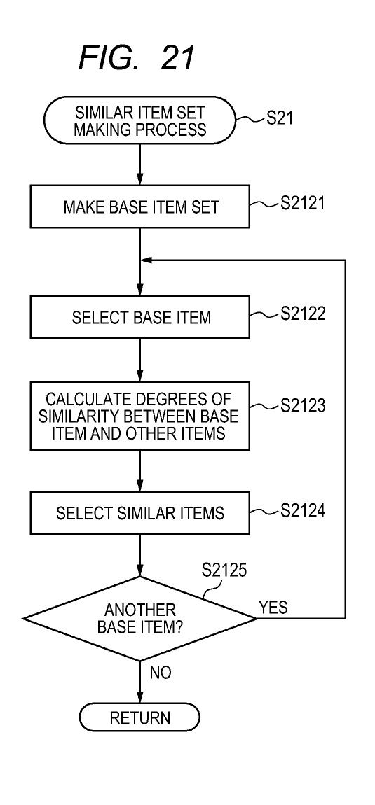

The process of making the similar item set (the step S21) by the information selecting device 10a will be described below in detail with reference to a flowchart of FIG. 21.

In a step S2121 of FIG. 21, the similar item set making section 104a makes a base item set. In the case where recommendation information is made at a timing when a recommendation information request message is received from another device (a terminal device 30 or the item providing server 20) as mentioned above, an item ID or IDs in the received message are placed in the base item set. In the case where recommendation information is made at a timing when item attribute information to be stored in the item attribute store section 101 is changed, all item IDs present in the item attribute store section 101 at that moment are read out before being placed in the base item set.

Next, in a step S2122, the similar item set making section 104a selects, from the base item set, one item which has not yet been processed. The selected item is labeled as the base item x.

Next, in a step S2123, the similar item set making section 104a calculates the degree W[x][y] of similarity between the base item x and another item y (x≠y) in the item attribute store section 101. For example, when M items except the base item x are in the item attribute store section 101, M similarity degrees are calculated.

Specifically, a count is made as to the number of heads in the item attribute information piece about the base item x which are equal in contents to corresponding heads in the item attribute information piece about the item y. Then, the counted number is labeled as a calculated similarity degree. For example, when the heads “creator” and “category” in the item attribute information piece about the base item x are equal in contents to those in the item attribute information piece about the item y, a calculated similarity degree is set to “2”.

A calculated similarity degree may be equal to the counted head number divided by the number of all the heads. In this case, for example, when each item attribute information piece has 10 different heads and the counted head number is “2”, the calculated similarity degree is 2/10 (=0.2).

In the similarity degree calculation process, concerning the head “item time information”, the two may be regarded as equal in head contents when the time difference between the two is in a prescribed interval of time. Concerning the head “price”, the two may be regarded as equal in head contents when the price difference between the two is less than a prescribed value. The number of keywords (words and character sets) common to the contents of the heads “title” and “description information” in the two may be used for a calculated similarity degree.

A set of IDs and keywords in the item attribute information piece about the base item x is denoted by H[x], and a set of IDs and keywords in the item attribute information piece about the item y is denoted by H[y]. The number of IDs and keywords common to the item attribute information pieces about the items x and y is denoted by |H[x]∩H[y]|, and the number of IDs and keywords in at least one of the item attribute information pieces about the items x and y is denoted by |H[x]∪H[y]|. The degree W[x][y] of similarity between the item x and the item y may be calculated by using a Jaccard coefficient as expressed in the following equation.

$$W [ x ] [ y ] = \frac{\vert H [ x ] ⋂ H [ y ] \vert}{\vert H [ x ] ⋃ H [ y ] \vert}$$

Subsequent steps S2124 and S2125 are the same as the steps S2115 and S2116 in the first embodiment of this invention.

As described above, in the second embodiment of this invention, the information selecting device 10a does not need the use history store section 102 so that the cost of the information selecting device 10a can be reduced. Since the degrees of similarities between items are calculated by using item attribute information pieces, similarity degree calculation is possible even for a base item which has not been used by a user or users at all so that corresponding recommendation information can be made.

### ADVANTAGES OF THE INVENTION

In the prior-art system, goods (items) in the recommendation information are limited to those accorded with the sales policy so that the number of goods which can be recommended is small and sufficiency is not available depending the contents of recommendation rules set by the seller in some cases. For example, when the number of goods registered in the recommendation rules by the seller is small, there occurs the problem that the number of goods which can be recommended is small. In some cases, to recommend a sufficient number of goods, it is necessary to properly set the recommendation rules and a specialist for setting the recommendation rules is necessary so that the number of steps of setting the recommendation rules causes a burden.

On the other hand, according to the first and second embodiments of this invention, when the number of item IDs in the recommended item condition store section 103 is small, the first rate R1 is small. Accordingly, the third rate R3 is relatively small while the value of (1−R3) is relatively great. Since items not accorded with the sales policy are placed in the recommendation information at a rate of (1−R3), a sufficient number of items can be recommended regardless of the way of setting the recommendation rules.

According to the first and second embodiments of this invention, for each base item being a trigger for outputting recommendation information, calculation is made as to an item characteristic value representing the strength of the relation between the base item and the recommended item conditions (sales policy). For a base item relating to an item characteristic value satisfying prescribed conditions, adjustment is properly done in the range where the rate in number of items accorded with the recommended item conditions in the recommendation information becomes less than 1. Thus, items which have high degrees of similarity with the base item and are not biased toward the sales policy only, and which moderately reflects the sales policy can be selected to make the recommendation information. Therefore, it is possible to reduce a risk of causing the user to feel the recommendation information as a press by the seller, and it is possible to provide recommendation information that can easily be accepted by the user. Thus, it is possible to promote item use by the user.

In the first and second embodiments of this invention, there are made a first set being a set of items having high degrees of similarity with the base item, and a second set being a set of other items. The item number rates of accordance with the recommended item conditions in the two sets are calculated, and the item characteristic value is calculated by using the two calculated rates. Therefore, it is possible to accurately quantify the strength of the relation between the base item and the recommended item conditions (sales policy) regardless of the way of setting the recommended item conditions. Accordingly, it is possible to make recommendation information that can more easily be accepted by the user. In addition, it is possible to provide the following advantage also. At the time of changing the sale conditions, the seller does not need to ask the manager of the information selecting device 10 (or 10a) to change parameters such as the threshold values in the recommendation process. Thus, the sale conditions can be freely and easily changed.

What is claimed is:

1. An item selecting apparatus comprising:
a similar item set making section selecting a first prescribed number of items or less items in order of degree of similarity with a target item from the highest or items with degrees of similarity with the target item which are equal to or greater than a first prescribed value, and making the selected items into a similar item set corresponding to the target item;
a first rate calculating section calculating, with respect to a first set of items being some or all of the items in the similar item set, calculating a first rate of the number of items satisfying recommended item conditions representing conditions for judging as items to be recommended to the number of all items;
an item characteristic value calculating section calculating an item characteristic value representing the strength of a relation between the target item and the recommended item conditions by using the first rate; and
an item selecting section selecting, from items in the similar item set, items including items satisfying the recommended item conditions to make an associated item set corresponding to the target item;
wherein the item selecting section makes the associated item set so that when the item characteristic value satisfies prescribed item characteristic value conditions, the rate of the number of items in the associated item set which satisfy the recommended item conditions to the number of all items in the associated item set will be greater than the first rate and smaller than 1 except for a case where the first rate is 1.

2. An item selecting apparatus as recited in claim 1, wherein when the item characteristic value does not satisfy the prescribed item characteristic value conditions, the item selecting section makes the associated item set so that the rate of the number of items in the associated item set which satisfy the recommended item conditions to the number of all items in the associated item set will be the first rate.

3. An item selecting apparatus as recited in claim 1, further comprising a second rate calculating section making a second set being a set of items including items except the items in the first set, the second rate calculating section calculating, with respect to the second set, a second rate in number of items satisfying the recommended item conditions, wherein the item characteristic value calculating section calculates the item characteristic value for the target item by using the first rate and the second rate.

4. An item selecting apparatus as recited in claim 3, wherein the second rate calculating section makes a comparison item set of one or more items except the target item, and calculates degrees of similarities between each item and other items in the comparison item set, and selects a second prescribed number of items or less items in order of calculated similarity degree from the highest or selects items corresponding to calculated similarity degrees equal to or greater than a second prescribed value to make the second set.

5. An item selecting apparatus as recited in claim 3, wherein the second rate calculating section calculates degrees of similarities between the target item and items except the target item, and selects items in ranks later than that corresponding to the first prescribe number if the items are sorted in order of calculated similarity degree from the highest or selects items corresponding to calculated preference degrees less than the first prescribed value to make the second set.

6. An item selecting apparatus as recited in claim 3, wherein the second rate calculating section calculates agreement degrees representing degrees to which the items in the second set satisfy the recommended item conditions respectively, and calculates a representative value of the calculated agreement degrees and labels the calculated representative value as the second rate.

7. An item selecting apparatus as recited in claim 3, wherein the item characteristic value calculating section calculates the item characteristic value by using a value resulting from subtracting the second rate from the first rate or a value resulting from dividing the first rate by the second rate.

8. An item selecting apparatus as recited in claim 1, wherein the first rate calculating section calculates agreement degrees representing degrees to which the items in the first set satisfy the recommended item conditions respectively, and calculates a representative value of the calculated agreement degrees and labels the calculated representative value as the first rate.

9. An item selecting apparatus as recited in claim 1, wherein the item selecting section makes the associated item set by using both items satisfying the recommended item conditions in the similar item set, and items not satisfying the recommended item conditions in the similar item set.

10. An item selecting apparatus as recited in claim 1, wherein in cases where the item characteristic value satisfies the prescribed item characteristic value conditions, the item selecting section makes the associated item set so that the rate of the number of items in the associated item set which satisfy the recommended item conditions to the number of all items in the associated item set will be greater than the first rate and smaller than 1 except a case where the first rate is 1, and will increase as the first rate increases.

11. An item selecting apparatus as recited in claim 1, wherein the prescribed item characteristic value conditions are conditions that the item characteristic value is between a third prescribed value and a fourth prescribed value greater than the third prescribed value, and wherein when the item characteristic value conditions are satisfied, the item selecting section makes the associated item set so that the rate of the number of items in the associated item set which satisfy the recommended item conditions to the number of all items in the associated item set will be greater than the first rate and smaller than 1 except a case where the first rate is 1, and wherein when the item characteristic value is greater than the fourth prescribed value, the item selecting section makes the associated item set so that the rate of the number of items in the associated item set which satisfy the recommended item conditions to the number of all items in the associated item set will be smaller than the first rate.

12. An item selecting apparatus as recited in claim 1, wherein use histories represent correspondences between users and items used by the users, and a range in ranks of the items in the use histories about number of times of item use or a range in ranks of the items in the use histories about number of users who have used an item is set in the recommended item conditions.

13. An item selecting apparatus as recited in claim 1, wherein use histories represent correspondences between users and items used by the users, and a range in numbers of times of use of the items in the use histories or a range in per-item numbers of users who have used the items in the use histories is set in the recommended item conditions.

14. An item selecting apparatus as recited in claim 1, further comprising an output section outputting the associated item set via a network.

15. In an information processing apparatus, a method of selecting items, comprising:
a similar item set making step of selecting a first prescribed number of items or less items in order of degree of similarity with a target item from the highest or items with degrees of similarity with the target item which are equal to or greater than a first prescribed value, and making the selected items into a similar item set corresponding to the target item;
a first rate calculating step of calculating, with respect to a first set of items being some or all of the items in the similar item set, calculating a first rate of the number of items satisfying recommended item conditions representing conditions for judging as items to be recommended to the number of all items;
an item characteristic value calculating step of calculating an item characteristic value representing the strength of a relation between the target item and the recommended item conditions by using the first rate; and
an item selecting step of selecting, from items in the similar item set, items including items satisfying the recommended item conditions to make an associated item set corresponding to the target item;
wherein the item selecting step makes the associated item set so that when the item characteristic value satisfies prescribed item characteristic value conditions, the rate of the number of items in the associated item set which satisfy the recommended item conditions to the number of all items in the associated item set will be greater than the first rate and smaller than 1 except for a case where the first rate is 1.

16. A method as recited in claim 15, wherein when the item characteristic value does not satisfy the prescribed item characteristic value conditions, the item selecting step makes the associated item set so that the rate of the number of items in the associated item set which satisfy the recommended item conditions to the number of all items in the associated item set will be the first rate.

17. A method as recited in claim 15, further comprising a second rate calculating step of making a second set of items including items except the items in the first set, the second rate calculating step calculating, with respect to the second set, a second rate of the number of items satisfying the recommended item conditions to the number of all items, wherein the item characteristic value calculating step calculates the item characteristic value for the target item by using the first rate and the second rate.

18. A computer program enabling an information processing apparatus to function as:
a similar item set making section selecting a first prescribed number of items or less items in order of degree of similarity with a target item from the highest or items with degrees of similarity with the target item which are equal to or greater than a first prescribed value, and making the selected items into a similar item set corresponding to the target item;
a first rate calculating section calculating, with respect to a first set of items being some or all of the items in the similar item set, calculating a first rate of the number of items satisfying recommended item conditions representing conditions for judging as items to be recommended to the number of all items;
an item characteristic value calculating section calculating an item characteristic value representing the strength of a relation between the target item and the recommended item conditions by using the first rate; and
an item selecting section selecting, from items in the similar item set, items including items satisfying the recommended item conditions to make an associated item set corresponding to the target item;
wherein the item selecting section makes the associated item set so that when the item characteristic value satisfies prescribed item characteristic value conditions, the rate of the number of items in the associated item set which satisfy the recommended item conditions to the number of all items in the associated item set will be greater than the first rate and smaller than 1 except for a case where the first rate is 1.

19. A computer program as recited in claim 18, wherein when the item characteristic value does not satisfy the prescribed item characteristic value conditions, the item selecting section makes the associated item set so that the rate of the number of items in the associated item set which satisfy the recommended item conditions to the number of all items in the associated item set will be the first rate.

20. A computer program as recited in claim 18, enabling the information processing apparatus to further function as a second rate calculating section making a second set of items including items except the items in the first set, the second rate calculating section calculating, with respect to the second set, a second rate of the number of items satisfying the recommended item conditions to the number of all items, wherein the item characteristic value calculating section calculates the item characteristic value for the target item by using the first rate and the second rate.
